(19) United States
(12) Patent Application Publication
(10) Pub. No.: US 2026/0120566 A1
(43) Pub. Date: Apr. 30, 2026

(54) ASSOCIATING TRAFFIC CONTROL DEVICES TO LANES FOR AUTONOMOUS OR SEMI- AUTONOMOUS SYSTEMS AND APPLICATIONS

(71) Applicant: NVIDIA Corporation, Santa Clara, CA (US)

(72) Inventor: Rui Shen, San Jose, CA (US)

(21) Appl. No.: 18/930,828

(22) Filed: Oct. 29, 2024

(51) Int. Cl. G08G 1/07; G06N 3/088

(52) U.S. Cl. CPC G08G 1/07; G06N 3/088

(57) ABSTRACT

In various examples, machine learning models may be trained and used to determine associations between traffic control devices (e.g., traffic signs, traffic lights, etc.) and lane segments of a driving surface. The systems and methods of the present disclosure may effectively combine rule-based methods and machine-learning based methods for traffic control device to lane association. For instance, training data may be synthetically generated based on traffic regulations relating to placement of traffic lights, and machine learning models may be trained to associate traffic lights to respective lanes using the training data with ground truth generated by rules. As such, image data may not be needed for the machine learning models to predict light to lane associations. Instead, given a set of non-image features indicative of lane segment and traffic light geometry and/or semantics, the machine learning models may predict the associated lane segment for each traffic light.

### BACKGROUND

For an autonomous or semi-autonomous vehicle to navigate safely through an environment, the vehicle may, at times, need to be able to identify which traffic control signals correspond to which lanes. This capability may help ensure that the vehicle understands the current state of the traffic control signals, as well as their relevance to the vehicle's specific position and intended path, as well as to help understand which traffic controls correspond to other vehicles in the area. For instance, misinterpreting a traffic light may lead to unsafe maneuvers, such as proceeding through a red light intended for another lane or misjudging the timing for a turn. By effectively discerning the association between traffic signals and the corresponding lanes, the vehicle may make informed decisions, ensuring compliance with traffic regulations and enhancing overall safety in complex driving scenarios.

In general, existing methods for associating traffic lights with lanes can be divided into two main categories, those being rule-based and machine learning-based approaches. Rule-based methods typically rely on handcrafted heuristics derived from traffic regulations and observations, allowing for quick updates when new edge cases arise. However, these heuristics, which may be limited by the number of observations, can lead to errors in unfamiliar scenarios. Additionally, as the diversity of situations increases, the number of necessary heuristics expands, complicating code maintenance.

On the other hand, machine learning methods may handle vast amounts of training data that encompass a wider array of scenarios than those typically encountered by developers. However, a significant drawback to these methods is the high cost of collecting and labeling this extensive data, as human annotators may be required to meticulously review each sample. These methods are normally based on pixel-derived image features. These methods may also struggle with the need for significant training data to capture variations in scene appearance, as well as the challenge of representing many possible combinations of traffic light placements and lane configurations.

### SUMMARY

Embodiments of the present disclosure relate to associating traffic control devices to lanes for autonomous or semi-autonomous systems and applications. Systems and methods are disclosed that may be used to train and use machine learning models (e.g., deep neural networks) to determine associations between traffic control devices (e.g., traffic signs, traffic lights, etc.) and lane segments of a driving surface. The systems and methods of the present disclosure may effectively combine rule-based methods and machine-learning based methods for traffic control device to lane association. For instance, training data may be synthetically generated based on traffic regulations relating to placement of traffic lights, and machine learning models may be trained to associate traffic lights to respective lanes using the training data with ground truth generated by rules. As such, image data may not be needed for the machine learning models to predict light to lane associations. Instead, given a set of non-image features indicative of lane segment and traffic light geometry and/or semantics, the machine learning models may predict the associated lane segment for each traffic light.

In contrast to conventional systems, the systems of the present disclosure, in some embodiments, are able to train machine learning models to accurately predict traffic control device to lane associations in unseen scenarios without having to modify hardcoded rules when new scenarios are encountered. Additionally, in contrast to the conventional systems, the systems of the present disclosure may be easily maintained by managing a single machine learning model as opposed to managing complex logic in a target deployment platform. For instance, rules may be expanded to high complexity scenarios during training, while in deployment the systems may include a single—and easy to maintain—learned model. Further, the systems of the present disclosure are able to train models to make traffic control device to lane associations without using image data as input. As such, the systems are able to synthesize training data based on traffic regulations for traffic light placement in intersections and other scenarios, as well as generate ground truth based on rules.

### BRIEF DESCRIPTION OF THE DRAWINGS

The present systems and methods for associating traffic control devices to lanes for autonomous or semi-autonomous systems and applications are described in detail below with reference to the attached drawing figures, wherein:

FIG. 1 is a data flow diagram illustrating an example of a process for associating traffic control devices to lane segments, in accordance with some embodiments of the present disclosure;

FIG. 2 illustrates an example of a scenario in which traffic control device to lane associations may be determined, in accordance with some embodiments of the present disclosure;

FIG. 3 is a data flow diagram illustrating an example of a process for a machine learning model to make traffic control signal to lane associations in scenarios similar to the scenario of FIG. 2, in accordance with some embodiments of the present disclosure;

FIG. 4 illustrates another example scenario in which traffic control device to lane associations may be determined, in accordance with some embodiments of the present disclosure;

FIG. 5 is a data flow diagram illustrating an example of another process for a machine learning model to make traffic control signal to lane associations in scenarios similar to the scenario of FIG. 4, in accordance with some embodiments of the present disclosure;

FIG. 6 is a data flow diagram illustrating an example process for training one or more machine learning models to determine associations between traffic control devices and corresponding lanes, in accordance with some embodiments of the present disclosure;

FIG. 7 illustrates an example of a system that may perform one or more of the processes described herein, in accordance with some embodiments of the present disclosure;

FIG. 8 is a flow diagram illustrating an example of a method for associating active traffic control signals to lane segments, in accordance with some embodiments of the present disclosure;

FIG. 9 is a flow diagram illustrating an example of a method for associating traffic control devices to lanes, in accordance with some embodiments of the present disclosure;

FIG. 10 is a flow diagram illustrating an example of a method for synthetically generating data for use in training a machine learning model to determine traffic control device to lane associations, in accordance with some embodiments of the present disclosure;

FIG. 11A is an illustration of an example autonomous vehicle, in accordance with some embodiments of the present disclosure;

FIG. 11B is an example of camera locations and fields of view for the example autonomous vehicle of FIG. 11A, in accordance with some embodiments of the present disclosure;

FIG. 11C is a block diagram of an example system architecture for the example autonomous vehicle of FIG. 11A, in accordance with some embodiments of the present disclosure;

FIG. 11D is a system diagram for communication between cloud-based server(s) and the example autonomous vehicle of FIG. 11A, in accordance with some embodiments of the present disclosure;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

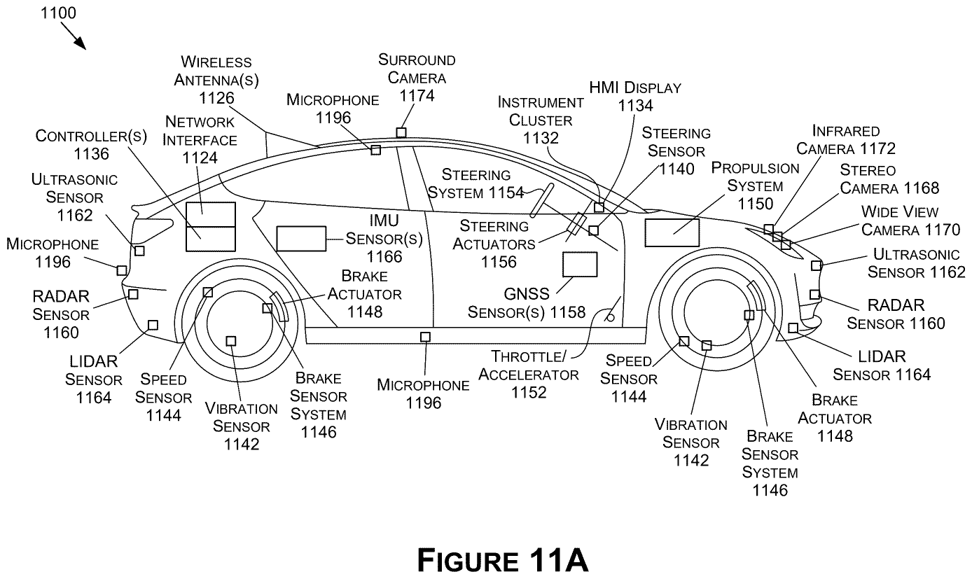

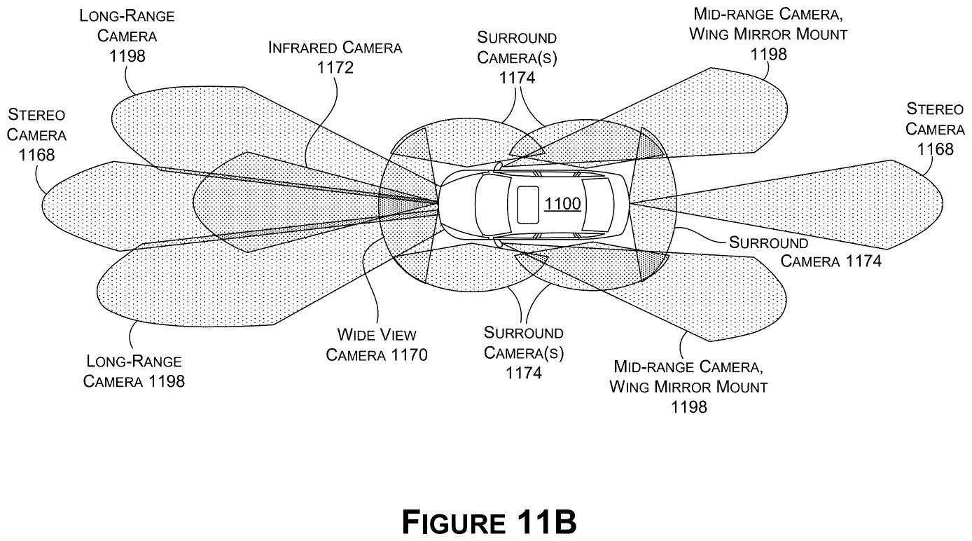

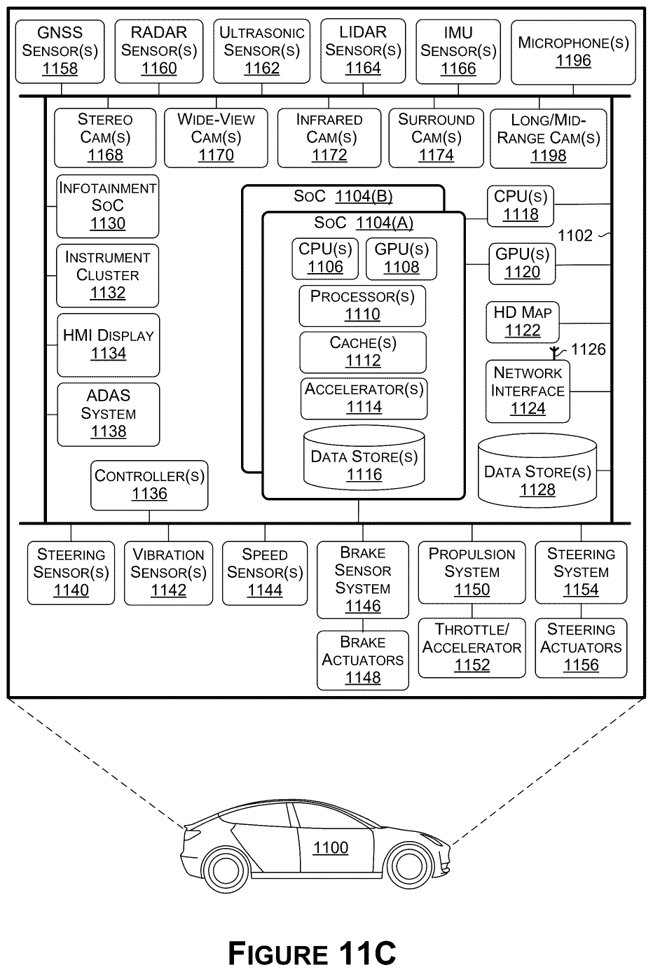

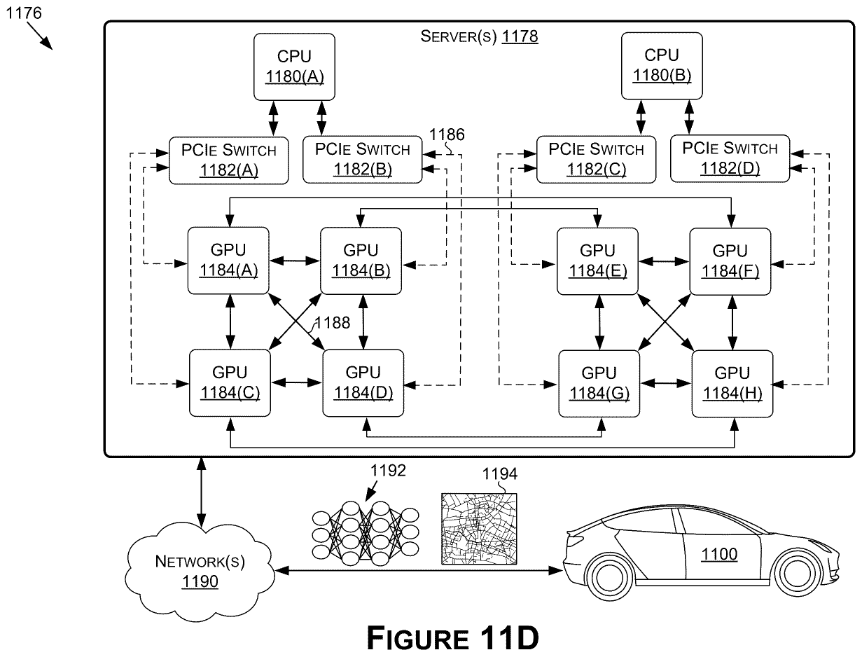

Systems and methods are disclosed related to associating traffic control devices to lanes for autonomous or semi-autonomous systems and applications. Although the present disclosure may be described with respect to an example autonomous or semi-autonomous vehicle or machine 1100 (alternatively referred to herein as “vehicle 1100,” “ego-vehicle 1100,” “ego-machine 1100,” or “machine 1100,” an example of which is described with respect to FIGS. 11A-11D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to associating traffic lights to lanes for autonomous or semi-autonomous navigation, this is not intended to be limiting, and the systems and methods described herein may be used in augmented reality, virtual reality, mixed reality, robotics, security and surveillance, autonomous or semi-autonomous machine applications, and/or any other technology spaces where associating traffic control annotations (e.g., traffic lights, traffic signs, etc.) to lanes may be used.

In general, training a DNN or other machine learning model to make traffic control device to lane associations normally requires a large amount of labeled data to cover a variety of scenarios. In some examples, to reduce the requirements of human labeled data, the systems of the present disclosure may decouple the problem of traffic control device to lane association from the problem of traffic control device detection and classification and the problem of lane detection and lane direction classification, which may allow the systems to induce the ground truth of traffic control device to lane association by rule-based reasoning. Based at least on the decoupling of these problems, the systems of the present disclosure may combine rule-based methods and machine learning-based methods to identify traffic control device to lane associations.

For instance, the systems of the present disclosure may use rules to generate pseudo ground truth to train a machine learning model. In such examples, human labeling of traffic control device to lane associations in each frame may not be required, and training data may be purely generated based on traffic regulations regarding placement of traffic control devices (e.g., traffic lights, traffic signs, etc.). A DNN or other type of machine learning model for determining traffic control device to lane associations may then be trained, in some instances, using pure synthetic data with ground truth generated by rules. In some examples, such synthetic data may only need to contain metadata associated with lanes and traffic control devices. That is, there may be no need for the synthetic data to include synthetic image data. While all or most of the training data may come from synthetic sources, the training data may, in some cases, be supplemented by human-labeled real data for novel scenarios. Once a model is trained, the trained model may then be able to identify traffic control device to lane associations across a wide variety of scenarios without requiring image data or image features as input.

For example, a system(s) may obtain sensor data using one or more sensors of a machine. In some examples, the sensor data may include LiDAR data generated using one or more LiDAR sensors, RADAR data generated using one or more RADAR sensors, image data generated using one or more image sensors (e.g., one or more cameras), ultrasonic data generated using one or more ultrasonic sensors, or any other type of sensor data. The sensor data may be applied to one or more perception systems or components. For instance, the sensor data may be applied to a lane perception system and/or to a traffic control device perception system. In various examples, the lane perception system may be configured to generate various geometric and/or semantic features associated with lanes and/or lane segments in an environment the machine is operating in. Similarly, the traffic control device perception system may be configured to generate various geometric and/or semantic features corresponding to traffic control devices in the environment, such as locations of the traffic control devices, states associated with the traffic control devices, geometries of the traffic control devices, or any other features.

As described herein, in some examples, the lane features and/or the traffic control device features may include or be non-image or non-pixel features. In other words, while the features may be derived by processing an image or some other form of visual or sensor data (e.g., point clouds, detection points, etc.), the features themselves may not include pixels, portions of an image, or other visual features. For example, features for the location and/or size of a traffic control device may be represented as a bounding box in 2D image and/or 3D space. As another example, features corresponding to lane segment geometry may be represented by the lane segment's centerline, left boundary, right boundary, starting point and end point, and this geometry may also be represented in 2D image and/or 3D space coordinates.

In some examples, the lane and traffic control device features may be applied as input data to one or more machine learning models (e.g., one or more DNNs), which may be trained to predict traffic control device to lane associations. For instance, given a set of input features indicative of one or more of lane segment geometry, lane segment direction, traffic light geometry (e.g., location, size, orientation), intended road users, and state as input, the machine learning model(s) may output active traffic light bulb to lane segment pair classifications. In some instances, such as for traffic light to lane association for lane segments on the ego road at an intersection, the machine learning model(s) may directly predict the associated lane direction for each active traffic light bulb. Additionally, or alternatively, the machine learning model(s) may predict associated lane directions for traffic control devices (e.g., signs, lights, etc.).

In some instances, the machine learning model(s) may include one or more embedding layers. The embedding layer(s) may project the lane features and traffic control device features into an embedding space before feeding to one or more backbone layers. Depending on the type of the input features, the machine learning model(s) may use different embedding layers to perform projection. For example, for discrete values (e.g., discrete lane directions and discrete traffic light bulb states), the machine learning model(s) may use a lookup table, which may be hardcoded or learned. As another example, for continuous values (e.g., lane centerline 2D coordinates and traffic light 2D coordinates), the machine learning model(s) may use a multi-layer perception. In some examples, the machine learning model(s) may expand these embeddings to be of a specific size (e.g., N×M) in the first two dimensions, and lane segment embeddings and traffic light embeddings may be concatenated to be used by the machine learning backbone. For example, an N×K′ embedding may be replicated M times to form an N×M×K′ embedding, an M×L′ embedding may be replicated N times to form an N×M×L′ embedding, and then the expanded embeddings may be concatenated to form an N×M×(K′+L′) embedding before being applied to the backbone layer(s). The backbone layer(s) may, in some examples, include one or more of a multi-layer perceptron, a convolutional neural network, a transformer, a recurrent neural network, a graph neural network, and/or a combination thereof, or any other types of neural networks.

As described herein, the features corresponding to the traffic control device(s) and/or the lane segment(s) may, in some instances, be applied as input vectors to the machine learning model(s). For instance, a first number (e.g., “N”) of K-dimensional vectors may be applied to the machine learning model(s), where each K-dimensional vector may represent the geometry and semantics of a lane segment. Additionally, a second number (e.g., “M”) of L-dimensional vectors may be applied to the machine learning model(s), where each L-dimensional vector may represent the geometry and semantics of a traffic control device (e.g., an active traffic light bulb). In such examples, the machine learning model(s) may output an N×M matrix, where each entry in the matrix may include a number representing the confidence that the Nth lane segment and the Mth traffic control device (e.g., active light bulb) is a valid pair.

In some examples, the machine learning model(s) may output a binary classification of the validity of each pair of traffic control device and lane segment in the scene. For instance, the machine learning model(s) may output a binary matrix where each entry corresponds to a pair of lane segment and traffic control device in the scene and indicates whether that pair is valid or not. Additionally, or alternatively, the machine learning model(s) may output a binary classification of the lane directions associated with each traffic control device (e.g., each active traffic light bulb). For instance, when considering active traffic light bulb to lane associations for lane segments on an ego road at an intersection and that lane segment direction is known for every lane segment on the ego road, the machine learning model(s) may, in effect, simplify the problem to classify, for each active traffic light bulb, the lane direction that each active traffic light bulb corresponds to. For example, one or more first active traffic light bulbs may be for one or more first lane directions of left turn and/or left U-turn, one or more second active traffic light bulbs may be for one or more second lane directions of going straight and right turn, etc.

In any example, the system(s) may use the machine learning model(s) to compute, based at least on the input data, a plurality of confidence scores indicative of whether one or more active signals of the plurality of traffic control devices correspond to one or more lane segments of the plurality of lane segments. Using the confidence scores, the system(s) may associate the active signal(s) with the lane segment(s). In some examples, the system(s) may cause a machine (e.g., an autonomous or semi-autonomous machine or vehicle) to perform one or more operations based at least on the association of the active signal(s) with the lane segment(s). For instance, the system(s) may use the associations to plan a path for the machine to follow, to adjust a speed of the machine (e.g., brake or come to a stop if the light for the lane is red, maintain speed if the light for the lane is green, etc.), or perform any other operations, as described herein.

In some examples, the system(s) may train the machine learning model(s) using synthetically generated training data. The system(s) may synthetically generate the training data (e.g., training inputs and/or ground truth data) from non-visual data using one or more rules associated with traffic control signal device positioning relative to one or more corresponding lane segments, in some instances.

For example, in the case of an intersection where more lanes than lights may be present, as well as multiple lane directions may be present, the system(s) may automatically generate ground truth traffic light to lane associations synthetically without using image information. To do this, the system(s) may generate lane geometry in 3D based on traffic regulations (e.g., where valid lane width range is specified) and given a random seed for the number of lanes. The system(s) may, in some instances, use camera intrinsic and extrinsic parameters to project the lane 3D geometry to 2D image space to obtain 2D geometry. For each lane segment, the system(s) may generate lane direction based on traffic regulations (e.g., in a right-hand driving country, right turn lanes should be the rightmost lanes). Additionally, the system(s) may generate traffic light geometry in 3D based on traffic regulations (e.g., where valid traffic light placement over lanes and traffic light sizes are specified) and given a random seed for number of lights. Using camera intrinsic and extrinsic parameters, the system(s) may project the traffic light 3D geometry to 2D image space to obtain 2D geometry. For each traffic light, the system(s) may generate targeted road users and state based on traffic regulations. For instance, for a traffic light bulb with more than one arrow (e.g., arrow left and arrow straight), the system(s) may represent this as multiple arrow states. Then, for each active traffic light bulb, the system(s) may assign its associated lane segments based on traffic regulations based on a priority order. An example of such a priority order may include, but is not limited to (e.g., other combinations or orders are possible), (1) lights for road users other than vehicles do not associate with any lane segment; (2) lights not facing ego road (from orientation) or not at current intersection (from 3D geometry); (3) if U-turn arrow bulb is present, it controls the U-turn lanes only; (4) if left arrow bulb is present, it controls the left turn lanes; and if U-turn bulb is not present, it also controls the left U-turn lanes; (5) if right arrow bulb is present, it controls the right turn lanes; (6) if solid circle bulb is present, it controls the remaining lanes; (7) if straight arrow bulb is present, it controls the straight lanes.

As another example, in the case of a highway on-ramp where a respective light may control each lane, the system(s) may automatically generate ground truth traffic light to lane associations synthetically without using image information. To do this, the system(s) may generate lane geometry in 3D based on traffic regulations (e.g., where valid lane width range is specified) and given a random seed for the number of lanes. The system(s) may, in some instances, use camera intrinsic and/or extrinsic parameters to project the lane 3D geometry to 2D image space to obtain 2D geometry. For each lane segment, the system(s) may generate lane direction based on traffic regulations (e.g., in a right-hand driving country, right turn lanes should be the rightmost lanes). Additionally, the system(s) may generate traffic light geometry in 3D based on traffic regulations (e.g., where valid traffic light placement over lanes and traffic light sizes are specified) and given a random seed for number of lights. Using camera intrinsic and/or extrinsic parameters, the system(s) may project the traffic light 3D geometry to 2D image space to obtain 2D geometry. For each traffic light, the system(s) may generate targeted road users and state as one of a red circle, yellow circle, and green circle. Then, for each active traffic light bulb, the system(s) may assign its associated lane segments based on proximity of the traffic light to the nearest lane segment in 3D.

In some examples, during training, the system(s) may apply sigmoid activation and use binary cross-entropy loss. However, any other loss function compatible with binary cross-entropy (such as focal loss) or uncertainty loss with corresponding activation function, labeling smoothing, and any other regularization method may be applied during training. To train the machine learning model(s), the system(s) may apply the synthetically generated training inputs to the machine learning model(s) and then compute losses between the outputs of the machine learning model(s) and the synthetically generated ground truth data. Based on the losses, the system(s) may update one or more parameters (e.g., weights, biases, etc.) of the machine learning model(s) to minimize or otherwise reduce the losses.

In some embodiments, the systems and methods described herein may be performed within a simulation environment (e.g., NVIDIA's DriveSIM) using simulated data (e.g., simulated sensor data of simulated sensors of a virtual or simulated machine). For example, simulated input data (e.g., perception data, non-image features, or any other data described herein) may be applied to the machine learning model(s) to determine traffic control device to lane associations in a simulation environment, and this information may be used to perform operations associated with the virtual machine within the simulation environment. These simulated operations may be used to test performance of the underlying algorithms, systems, and/or processes described herein prior to deploying them in the real-world.

In any example, such as where a simulation environment is used for testing, validation, training, etc., the simulation environment may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications. In some examples, the simulation environment may include a digital twin of a real environment, such as a digital twin of a specific stretch of roadway, a warehouse, a data center, an airport, a geographic area, a marine area, or any other real environment where autonomous or semi-autonomous machines may operate.

In some embodiments, teleoperation or remote control of a vehicle or other machine may be performed using a remote control or teleoperation system. For example, the systems and methods described herein may be used to identify traffic control signal to lane associations, which may be included in a visualization or mapping of an environment, to aid a remote operator in controlling—or providing waypoints or other indications of control or navigation—an autonomous or semi-autonomous machine through an environment.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice - such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs), vision language models (VLMs), and/or multi-modal language models, systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

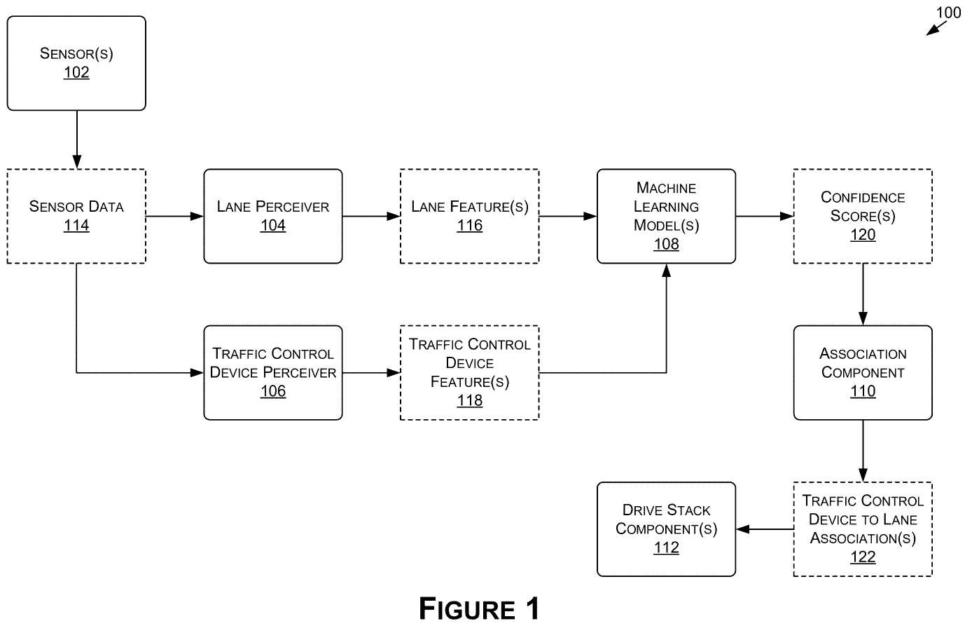

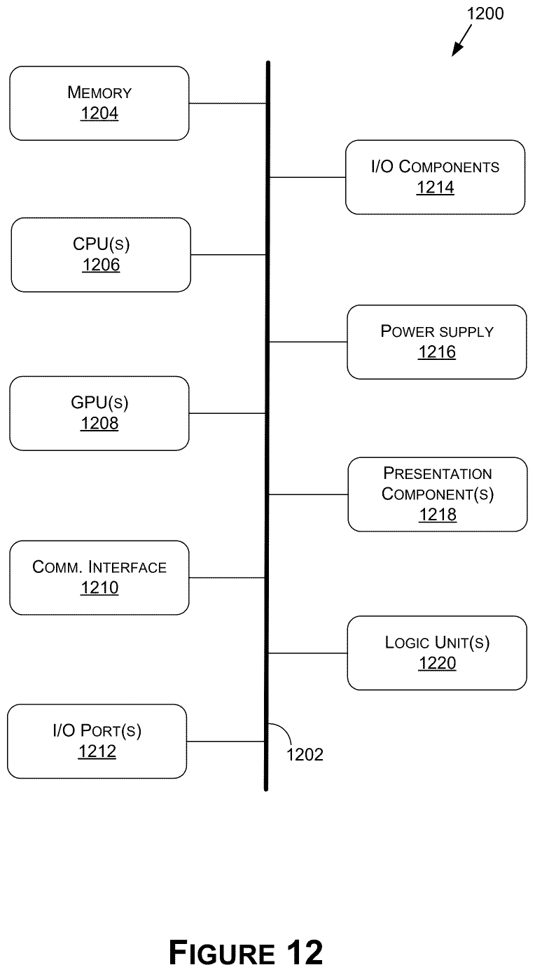

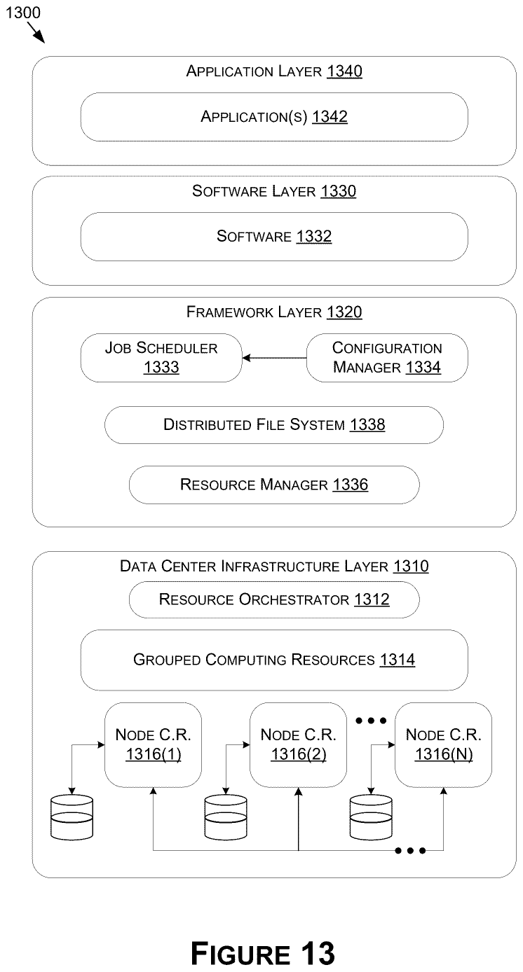

With reference to FIG. 1, FIG. 1 is a data flow diagram illustrating an example of a process 100 for associating traffic control devices to lane segments, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1100 of FIGS. 11A-11D, example computing device 1200 of FIG. 12, and/or example data center 1300 of FIG. 13.

The process 100 illustrated in the example of FIG. 1 may be implement using, amongst additional or alternative components, one or more sensors 102, a lane perceiver 104, a traffic control device perceiver 106, one or more machine learning models 108, an association component 110, and one or more drive stack components 112. As a brief overview of the process 100, the sensor(s) 102 may generate sensor data 114 that is applied as input to the lane perceiver 104 and the traffic control device perceiver 106. Using the sensor data 114, the lane perceiver 104 may generate one or more lane features 116 and the traffic control device perceiver 106 may generate one or more traffic control device features 118. The machine learning model(s) 108 may obtain and use the lane feature(s) 116 and the traffic control device feature(s) 118 to compute one or more confidence scores 120, which may represent one or more probabilities of certain traffic control device to lane associations being valid pairs. The association component 110 may use the confidence score(s) 120 to determine one or more traffic control device to lane associations 122. The traffic control device to lane association(s) 122 may then be provided to the drive stack component(s) 112, which may use the association(s) to control one or more operations of the machine.

In some examples, the sensor(s) 102 may include any one or more of the sensors of the autonomous vehicle 1100. For instance, the sensor(s) 102 may include one or more of a LiDAR sensor(s), a RADAR sensor(s), an image sensor(s) (e.g., camera(s)), an ultrasonic sensor(s), or any other sensors described herein. As such, the sensor data 114 may include LiDAR data generated using the LiDAR sensor(s), RADAR data generated using the RADAR sensor(s), image data generated using the image sensor(s), ultrasonic data generated using the ultrasonic sensor(s), or any other type of sensor data. The sensor data 114 may be applied to one or more perception systems or components. For instance, the sensor data 114 may be applied to the lane perceiver 104 and to the traffic control device perceiver 106. In various examples, the lane perceiver 104 may be configured to generate one or more lane features 116, which may include various geometric and/or semantic features (e.g., lane direction) associated with lanes and/or lane segments in an environment the machine is operating in. Similarly, the traffic control device perceiver 106 may be configured to generate one or more traffic control device features 118, which may include various geometric and/or semantic features corresponding to traffic control devices in the environment, such as locations of the traffic control devices, states associated with the traffic control devices, geometries of the traffic control devices, or any other features.

As described herein, in some examples, the lane feature(s) 116 and/or the traffic control device feature(s) 118 may include or be non-image or non-pixel features. In other words, while the features may be derived by processing image data or some other form of visual data, the features themselves may not include pixels, portions of an image, or other visual features. For example, features for the location and/or size of a traffic control device may be represented as a bounding box in 2D and/or 3D image space. As another example, features corresponding to lane segment geometry may be represented by the lane segment's centerline, left boundary, right boundary, starting point and end point, and this geometry may also be represented in 2D and/or 3D image-space coordinates.

As illustrated in the example of FIG. 1, the lane feature(s) 116 and the traffic control device feature(s) 118 may be applied as inputs to the machine learning model(s) 108, which may be trained to predict traffic control device to lane associations. For instance, given a set of input features indicative of one or more of lane segment geometry, lane segment direction, traffic control device geometry (e.g., location, size, orientation), intended road users, and state as input, the machine learning model(s) 108 may output one or more confidence scores 120 indicating one or more traffic control device to lane segment pair classifications. In some instances, such as for active traffic light to lane association for lane segments on the ego road at an intersection, the machine learning model(s) 108 may directly predict the associated lane direction for each active traffic light bulb.

Although examples are described herein with respect to using neural networks, and specifically DNNs in machine learning models, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural rendering field (NeRF) models, models with encoder-only architectures, models with decoder-only architectures, models with encoder-decoder architectures, generative machine learning models, language models, large language models (LLMs), vision language models (VLMs), multi-modal language models (MMLMs), etc.), and/or other types of machine learning models.

In some instances, the machine learning model(s) 108 may include one or more embedding layers. The embedding layer(s) may project the lane feature(s) 116 and traffic control device feature(s) 118 into an embedding space before being applied to one or more backbone layers. Depending on the type of the input features, the machine learning model(s) 108 may use different embedding layers to perform projection. For example, for discrete values (e.g., discrete lane directions and discrete traffic light bulb states), the machine learning model(s) 108 may use a lookup table, which may be hardcoded or learned. As another example, for continuous values (e.g., lane centerline 2D coordinates and traffic light 2D coordinates), the machine learning model(s) 108 may use a multi-layer perception. In some examples, the machine learning model(s) 108 may expand these embeddings to be of a specific size (e.g., N×M) in the first two dimensions, and lane segment embeddings and traffic control device embeddings may be concatenated to be used by the machine learning backbone. For example, an N×K′ embedding may be replicated M times to form an N×M×K′ embedding, an M×L′ embedding may be replicated N times to form an N×M×L′ embedding, and then the expanded embeddings may be concatenated to form an N×M×(K′+L′) embedding before being applied to the backbone layer(s). The backbone layer(s) may, in some examples, include one or more of a multi-layer perceptron, a convolutional neural network, a transformer, a recurrent neural network, a graph neural network, and/or a combination thereof, or any other types of neural networks.

As described herein, the lane feature(s) 116 and/or the traffic control device feature(s) 118 may, in some instances, be represented as vectors that are input to the machine learning model(s) 108. For instance, the lane feature(s) 116 may include a first number (e.g., “N”) of K-dimensional vectors, where each K-dimensional vector may represent the geometry and semantics of a lane segment. Additionally, the traffic control device feature(s) 118 may include a second number (e.g., “M”) of L-dimensional vectors, where each L-dimensional vector may represent the geometry and semantics of a traffic control device (e.g., an active traffic light bulb). Additionally, in some examples, the confidence score(s) 120 output by the machine learning model(s) 108 may include an N×M matrix, where each entry in the matrix may include a number or value representing the confidence that the Nth lane segment and the Mth traffic control device (e.g., active light bulb) is a valid pair.

In some examples, the confidence score(s) 120 output by the machine learning model(s) 108 may include a binary classification of the validity of each pair of traffic control device and lane segment in the scene. For instance, the confidence score(s) 120 may include a binary matrix where each entry corresponds to a pair of lane segment and traffic control device in the scene and indicates whether that pair is valid or not. That is, the value or number in each entry may represent the confidence of whether that pair is valid. Additionally, or alternatively, the machine learning model(s) 108 may output a binary classification of the lane directions associated with each traffic control device (e.g., each active traffic light bulb). For instance, when considering active traffic light bulb to lane associations for lane segments on an ego road at an intersection and that lane segment direction is known for every lane segment on the ego road, the machine learning model(s) 108 may, in effect, simplify the problem to classify, for each active traffic light bulb, the lane direction that each active traffic light bulb corresponds to. For example, one or more first active traffic light bulbs may be for one or more first lane directions of left turn and/or left U-turn, one or more second active traffic light bulbs may be for one or more second lane directions of going straight and right turn, etc.

In some examples, the association component 110 may use the confidence score(s) 120 to generate the traffic control device to lane association(s) 122. Although described herein as associating traffic control devices to lane segments, this is not intended to be limiting, and the machine learning model(s) 108 and/or the association component 110 may determine, amongst additional or alternative things, associations between traffic control devices (e.g., traffic signs, traffic light fixtures/housings, etc.) and lane segments, associations between active traffic control signals (e.g., illuminated traffic light bulbs) and lane segments, associations between active traffic control signals and lane segment directions, etc. In some examples, the association component 110 may associate a traffic control device (or traffic control signal, active light bulb, etc.) with a lane segment based on the confidence score for that traffic control device to lane pair being the highest value confidence score, by being the highest value confidence score by more than a threshold, by having a confidence score that meets or exceeds a threshold value (e.g., 80% confidence, 90% confidence, etc.), or any other criteria or metric. For instance, if the association component 110 determines, based on the confidence score(s) 120, that a first confidence score for a first pairing between a first traffic control device and a first lane segment is greater than a second confidence score for a second pairing between the first traffic control device and a second lane segment and/or a third confidence score for a third pairing between a second traffic control device and the first lane segment, then the association component 110 may determine that the first pairing is the valid pairing. Additionally, in some examples, for the association component 110 to determine the first pairing is the valid pairing, the association component may determine that the first confidence score exceeds the second and/or third confidence scores by more than a threshold (e.g., 10% confidence, 20% confidence, 40% confidence, etc.).

In some examples, the traffic control device to lane association(s) 122 may be sent or provided to the drive stack component(s) 112. The drive stack component(s) 112 may use the traffic control device to lane association(s) 122 to cause the machine to perform one or more control operations. For instance, the drive stack component(s) may use the traffic control device to lane association(s) 122 to plan a path for the machine to follow, to adjust a speed of the machine (e.g., brake or come to a stop if the light for the lane is red, maintain speed if the light for the lane is green, etc.), or perform any other control operations, as described herein.

In various examples, the drive stack component(s) 112 may include a perception component, a model component, a planning component, a control component, an avoidance component, an actuation component, a wait perceiver, and/or other components corresponding to additional and/or alternative layers of the drive stack. These components may use the traffic control device to lane association(s) 122 as inputs to make various decisions on behalf of the machine.

The wait perceiver may be responsible to determining constraints on the machine as a result of rules, conventions, and/or practical considerations. For example, the rules, conventions, and/or practical considerations may be in relation to traffic lights, multi-way stops, yields, merges, toll booths, gates, police or other emergency personnel, road workers, stopped buses or other machines, one-way bridge arbitrations, ferry entrances, etc. Thus, the wait perceiver may be leveraged to identify potential obstacles and implement one or more controls (e.g., slowing down, coming to a stop, etc.) that may not have been possible relying solely on the obstacle perceiver.

The planning component may include a route planner, a lane planner, a behavior planner, and/or a behavior selector, among other components, features, and/or functionality. The route planner may use the information from the traffic control device to lane association(s) 122 to generate a planned path that may consist of GNSS waypoints (e.g., GPS waypoints), 3D world coordinates (e.g., Cartesian, polar, etc.) that indicate coordinates relative to an origin point on the machine, etc. The waypoints may be representative of a specific distance into the future for the machine, such as a number of city blocks, a number of kilometers, a number of feet, a number of inches, a number of miles, etc., that may be used as a target for the lane planner.

The avoidance component of the drive stack component(s) 112 may aid the machine in avoiding collisions with objects (e.g., dynamic and stationary objects) and/or avoiding violations of traffic rules. The avoidance component may use the traffic control to lane association(s) 122 to determine whether the intended behavior or path of the machine would violate traffic rules (e.g., run a red light, use an incorrect lane, etc.). In some examples, the avoidance component may ignore traffic laws, rules of the road, and courteous driving norms in order to ensure that collisions do not occur between the machine and any objects. As such, the obstacle avoidance layer may be a separate layer from the rules of the road layer, and the obstacle avoidance layer may ensure that the machine is only performing safe actions from an obstacle avoidance standpoint. The rules of the road layer, on the other hand, may ensure that machine obeys traffic laws and conventions, and observes lawful and conventional right of way (as described herein).

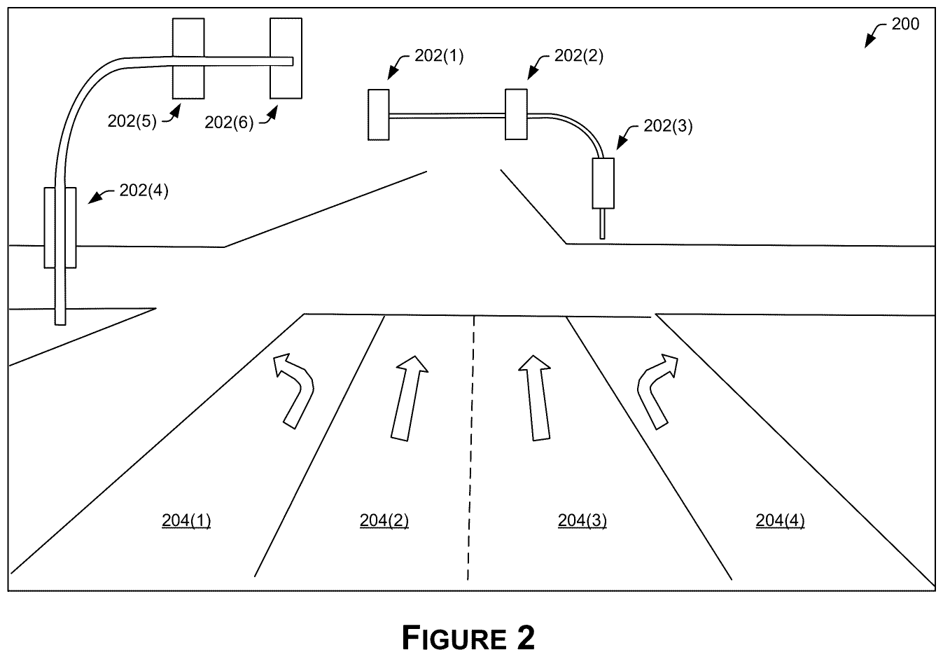

Referring now to FIG. 2, FIG. 2 illustrates an example of a scenario in which traffic control device to lane associations may be determined, in accordance with some embodiments of the present disclosure. An environment 200 may include a plurality of traffic control devices 202(1)-202(6) (hereinafter collectively referred to as “traffic control devices 202”) and a plurality of lanes 204(1)-204(4) (hereinafter collectively referred to as “lanes 204”). In such a scenario, the system(s) of the present disclosure may associate one or more of the traffic control devices 202 to one or more of the lanes 204. In the example of FIG. 2, the traffic control devices 202 correspond to traffic lights or traffic signals and, in some instances, the system(s) of the present disclosure may associate one or more active bulbs of the traffic control devices 202 to one or more lane directions associated with one or more of the lanes 204. For instance, lane features corresponding to the lanes 204 and traffic control device features corresponding to the traffic control devices 202 may be applied to a deep neural network, the deep neural network may use the features to compute confidence scores associated with possible pairings of the traffic control devices 202 to the lanes 204, and based on the confidence scores one or more of the traffic control devices 202 may be associated with one or more of the lanes 204. For instance, in the example of FIG. 2, a first traffic control device 202(1) may be associated with a first lane 204(1), a second traffic control device 202(2) may be associated with a second lane 204(2) and a third lane 204(3), and a third traffic control device 202(3) may be associated with a fourth lane 204(4). Additionally, in some instances, the system(s) may disregard the traffic control devices 202(4)-202(6) as these devices may be used to control traffic for non-ego lanes (e.g., opposing traffic lanes).

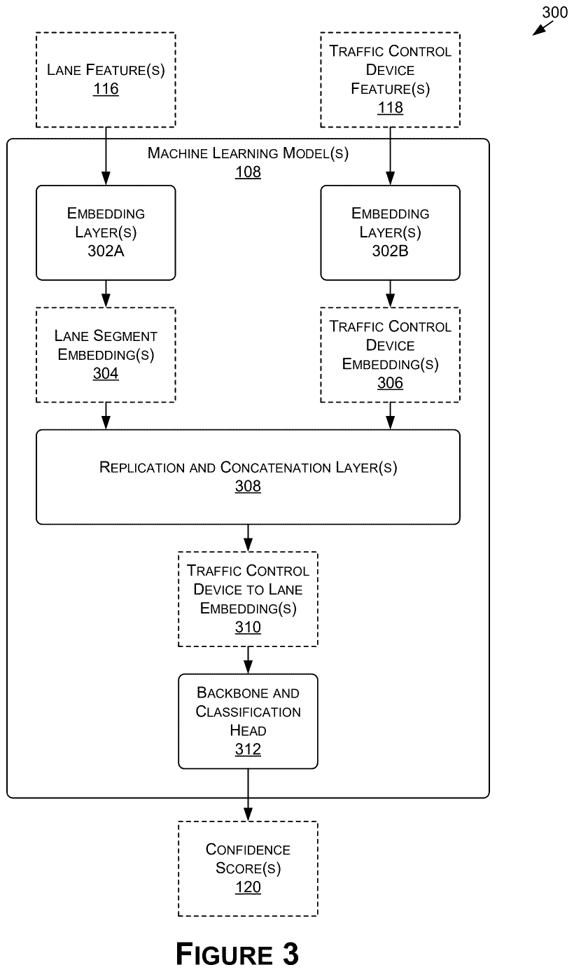

For instance, FIG. 3 is a data flow diagram illustrating an example of a process 300 for a machine learning model to make traffic control signal to lane associations in scenarios similar to the scenario illustrated in FIG. 2, in accordance with some embodiments of the present disclosure. As shown in the example of FIG. 3, one or more first embedding layers 302A may use the lane feature(s) 116 to generate one or more lane segment embeddings 304. Similarly, one or more second embedding layers 302B may use the traffic control device feature(s) 118 to generate one or more traffic control device embeddings 306. Although depicted as separate components, in some examples, the first embedding layer(s) 302A and the second embedding layers 302B may be the same component. The lane segment embedding(s) 304 and the traffic control device embedding(s) 306 may be fed into one or more replication and concatenation layers 308, and the replication and concatenation layer(s) 308 may generate one or more traffic control device to lane embeddings 310. A backbone and classification head 312 of the machine learning model(s) 108 may use the traffic control device to lane embedding(s) 310 to compute the confidence score(s) 120 indicative of one or more traffic control device to lane associations.

Referring back to the example of FIG. 2, in some examples, the system(s) may automatically generate ground truth data indicating traffic control device to lane associations synthetically without using image information. To do this for a scenario similar to that shown in the example of FIG. 2 (e.g., where a more complex intersection is involved), the system(s) may generate lane geometry in 3D based on traffic regulations (e.g., where valid lane width range is specified) and given a random seed for the number of lanes. The system(s) may, in some instances, use camera intrinsic and extrinsic parameters to project the lane 3D geometry to 2D image space to obtain 2D geometry. For each lane segment, the system(s) may generate lane direction based on traffic regulations (e.g., in a right-hand driving country, right turn lanes should be the rightmost lanes). Additionally, the system(s) may generate traffic light geometry in 3D based on traffic regulations (e.g., where valid traffic light placement over lanes and traffic light sizes are specified) and given a random seed for number of lights. Using camera intrinsic and extrinsic parameters, the system(s) may project the traffic light 3D geometry to 2D image space to obtain 2D geometry. For each traffic light, the system(s) may generate targeted road users and state based on traffic regulations. For instance, for a traffic light bulb with more than one arrow (e.g., arrow left and arrow straight), the system(s) may represent this as multiple arrow states. Then, for each active traffic light bulb, the system(s) may assign its associated lane segments based on traffic regulations based on a priority order. An example of such a priority order may include, but is not limited to (e.g., other combinations or orders are possible), (1) lights for road users other than vehicles do not associate with any lane segment; (2) lights not facing ego road (from orientation) or not at current intersection (from 3D geometry); (3) if U-turn arrow bulb is present, it controls the U-turn lanes only; (4) if left arrow bulb is present, it controls the left turn lanes; and if U-turn bulb is not present, it also controls the left U-turn lanes; (5) if right arrow bulb is present, it controls the right turn lanes; (6) if solid circle bulb is present, it controls the remaining lanes; (7) if straight arrow bulb is present, it controls the straight lanes.

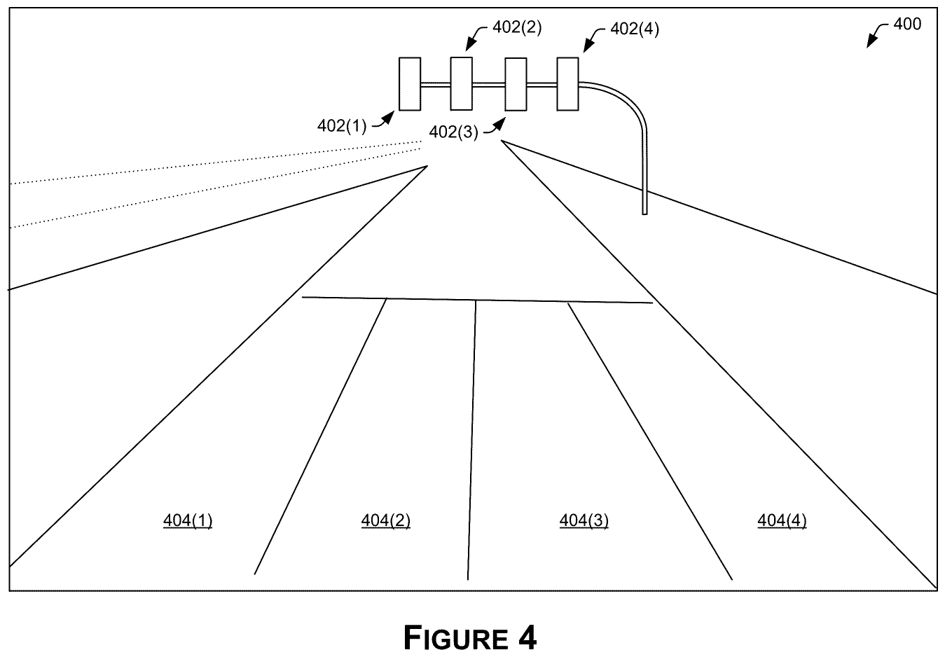

Referring now to FIG. 4, FIG. 4 illustrates another example scenario in which traffic control device to lane associations may be determined, in accordance with some embodiments of the present disclosure. An environment 400 may include a plurality of traffic control devices 402(1)-402(4) (hereinafter collectively referred to as “traffic control devices 402”) and a plurality of lanes 404(1)-404(4) (hereinafter collectively referred to as “lanes 404”). In such a scenario, the system(s) of the present disclosure may associate one or more of the traffic control devices 402 to one or more of the lanes 404. In the example of FIG. 4, the traffic control devices 402 correspond to traffic lights or traffic signals and, in some instances, the system(s) of the present disclosure may associate one or more active bulbs of the traffic control devices 402 to one or more of the lanes 404. For instance, lane features corresponding to the lanes 404 and traffic control device features corresponding to the traffic control devices 402 may be applied to a deep neural network, the deep neural network may use the features to compute confidence scores associated with possible pairings of the traffic control devices 402 to the lanes 404, and based on the confidence scores one or more of the traffic control devices 402 may be associated with one or more of the lanes 404. For instance, in the example of FIG. 4, a first traffic control device 402(1) may be associated with a first lane 404(1), a second traffic control device 402(2) may be associated with a second lane 404(2), a third traffic control device 402(3) may be associated with a third lane 404(3), and a fourth traffic control device 402(4) may be associated with a fourth lane 404(4).

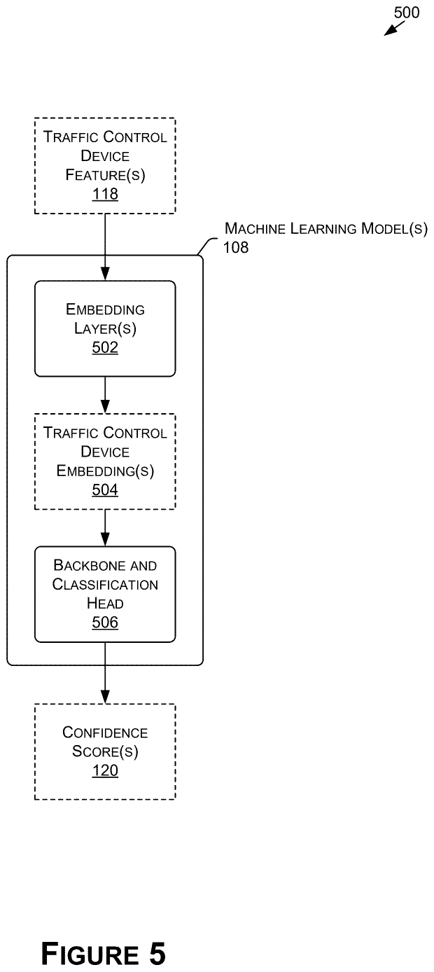

For instance, FIG. 5 is a data flow diagram illustrating an example of a process 300 for a machine learning model to make traffic control signal to lane associations in scenarios similar to the scenario illustrated in FIG. 4, in accordance with some embodiments of the present disclosure. As shown in the example of FIG. 5, one or more embedding layers 502 may use the traffic control device feature(s) 118 to generate one or more traffic control device embeddings 504. The traffic control device embedding(s) 504 may be fed into a backbone and classification head 506 of the machine learning model(s) 108, and the backbone and classification head 506 may use the traffic control device embedding(s) 504 to compute the confidence score(s) 120 indicative of one or more traffic control device to lane associations.

Referring back to the example of FIG. 4, in some examples, the system(s) may automatically generate ground truth data indicating traffic control device to lane associations synthetically without using image information. To do this for a scenario similar to that shown in the example of FIG. 4 (e.g., where a more simplified scenario is involved), the system(s) may automatically generate ground truth traffic light to lane associations synthetically without using image information. To do this, the system(s) may generate lane geometry in 3D based on traffic regulations (e.g., where valid lane width range is specified) and given a random seed for the number of lanes. The system(s) may, in some instances, use camera intrinsic and extrinsic parameters to project the lane 3D geometry to 2D image space to obtain 2D geometry. For each lane segment, the system(s) may generate lane direction based on traffic regulations (e.g., in a right-hand driving country, right turn lanes should be the rightmost lanes). Additionally, the system(s) may generate traffic light geometry in 3D based on traffic regulations (e.g., where valid traffic light placement over lanes and traffic light sizes are specified) and given a random seed for number of lights. Using camera intrinsic and extrinsic parameters, the system(s) may project the traffic light 3D geometry to 2D image space to obtain 2D geometry. For each traffic light, the system(s) may generate targeted road users and state as one of a red circle, yellow circle, and green circle. Then, for each active traffic light bulb, the system(s) may assign its associated lane segments based on proximity of the traffic light to the nearest lane segment in 3D.

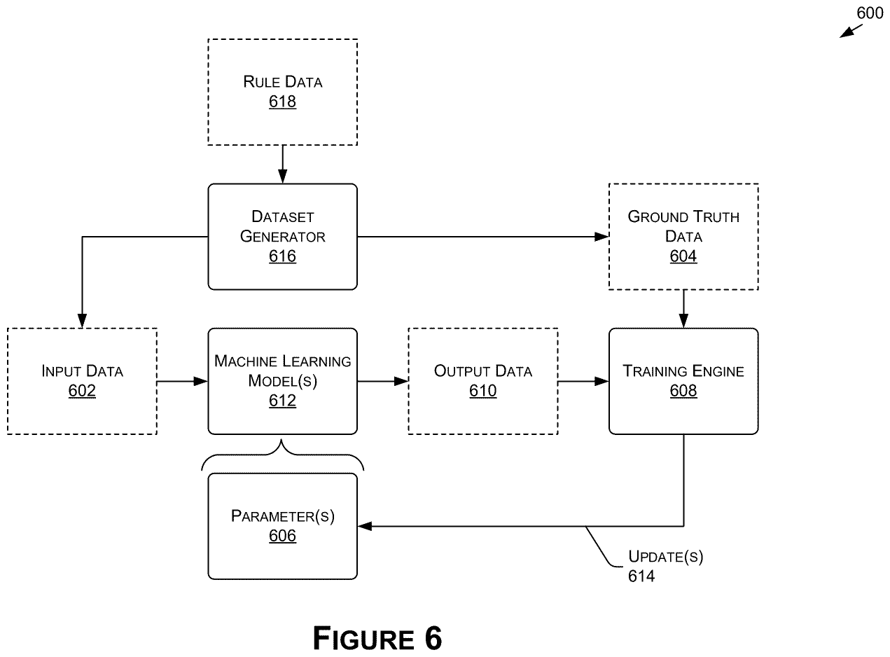

Referring now to FIG. 6, FIG. 6 is a data flow diagram illustrating an example process 600 for training one or more machine learning models to determine associations between traffic control devices and corresponding lanes, in accordance with some embodiments of the present disclosure. As shown, the machine learning model(s) 612 (which may correspond to the machine learning model(s) 108) may be trained using input data 602 (e.g., training inputs). The input data 602 may comprise feature vectors (e.g., non-image feature vectors) similar to the lane feature(s) 116 and/or the traffic control device feature(s) 118 described herein. The machine learning model(s) 612 may be trained using the training input data 602 as well as corresponding ground truth data 604 (which may correspond to the input data 602). In some examples, the ground truth data 604 may include various data indicating valid traffic control device to lane associations, including annotations, labels, masks, values (e.g., confidence values) and/or the like. For example, in some embodiments, the ground truth data 604 may indicate actual confidence values associated with potential pairings of traffic control devices and lanes from the input data 602.

The input data 602 and ground truth data 604 may be included as part of a training dataset generated (e.g., synthetically generated) by a dataset generator 616 based at least on rule data 618. For instance, the input data 602 may be synthesized based on traffic regulations for traffic lights placement in intersections and other scenarios, and the ground truth data 604 may be generated based on proximity of traffic lights to lanes and/or based on rules defining various traffic norms (e.g., left arrow bulbs control left turn lanes, right arrow bulbs control right turn lanes, solid circle bulbs control regular lanes, straight arrow bulbs control straight lanes, etc.), where no image data may be needed. Additionally, in any example, the ground truth data 604 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer).

A training engine 608 may use one or more loss functions that measure loss (e.g., error) in the output data 610 generated by the machine learning model(s) 612 as compared to the ground truth data 604 and/or the input data 602. In some examples, the training engine 608 may compare the output data 610 from the machine learning model(s) 612 to the input data 602, and update 614 one or more parameters 606 of the machine learning model(s) 612 based at least on the comparing. That is, the training engine 608 may update/optimize one or more parameters 606 associated with the machine learning model(s) 612 to reduce the losses/differences between the output data 610 (e.g., predicted traffic control device to lane associations and/or confidence) and the ground truth data 604 (e.g., ground truth traffic control device to lane associations and/or confidence). Any type of loss function may be used, such as cross entropy loss, mean squared error, mean absolute error, mean bias error, and/or other loss function types. In some examples, different outputs may have different loss functions. In such examples, the loss functions may be combined to form a total loss, and the total loss may be used to train (e.g., update the parameters of) the machine learning model(s) 612. In any example, backward pass computations may be performed to recursively compute gradients of the loss function(s) with respect to training parameters. In some examples, weight and biases of the machine learning model(s) 612 may be used to compute these gradients.

In some examples, the machine learning model(s) 612 may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model (e.g., weights and biases). In some instances, such as where the machine learning model(s) 612 is small enough (e.g., has a small enough number of parameters), the model(s) 612 may be included within the container itself. In some embodiments, the machine learning model(s) 612 described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) 612 described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) 612 (e.g., that has been optimized for high performance inference), an inference runtime software to execute the machine learning model(s) 612 and provide outputs/responses to inputs (e.g., user queries, prompts, etc.), and enterprise management software to provide health checks, identity, and other monitoring. In some embodiments, the inference microservice may include software to perform in-place replacement and/or updating to the machine learning model(s) 612. When replacing or updating, the software that performs the replacement/updating may maintain user configurations of the inference runtime software and enterprise management software.

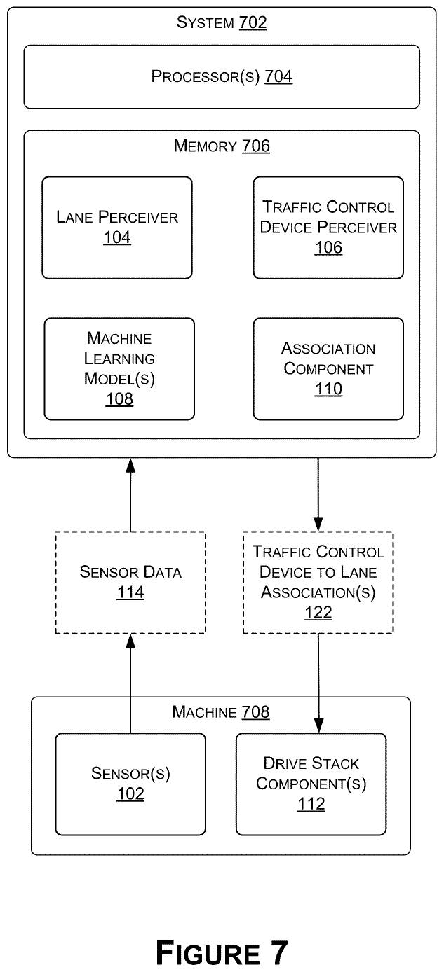

FIG. 7 illustrates an example of a system 702 that may perform one or more of the processes described herein, in accordance with some embodiments of the present disclosure. As shown, the system 702 (which may represent, and/or include, the example computing device(s) 1200 and/or the example data center 1300) may include one or more processors 704 (which may be similar to, and/or include, the CPUs 1206 and/or the GPUs 1208) and memory 706 (which may be similar to, and/or include, the memory 1204). For instance, the memory 706 may store one or more of the lane perceiver 104, the traffic control device perceiver 106, the machine learning model(s) 108, and/or the association component 110. Additionally, the processor(s) 704 may execute one or more of the lane perceiver 104, the traffic control device perceiver 106, the machine learning model(s) 108, and/or the association component 110 to perform one or more of the processes described herein.

For instance, the system 702 may receive sensor data 114 from the sensor(s) 102 of a machine 708 (which may correspond to the autonomous vehicle 1100). The sensor data 114 may be processed by the lane perceiver 104 and the traffic control device perceiver 106, which may output non-image features associated with lanes and traffic control devices in an environment. The non-image features may be applied to the machine learning model(s) 108, and the models may compute confidence scores associated with potential traffic control device to lane pairings. The association component 110 may use the confidence scores to associate one or more traffic control devices with one or more corresponding lane segments. These traffic control device to lane association(s) 122 may be sent to one or more of the drive stack component(s) 112 of the machine 708. The drive stack component(s) 112 may cause the machine 708 to perform one or more control operations based on the traffic control device to lane association(s) 122.

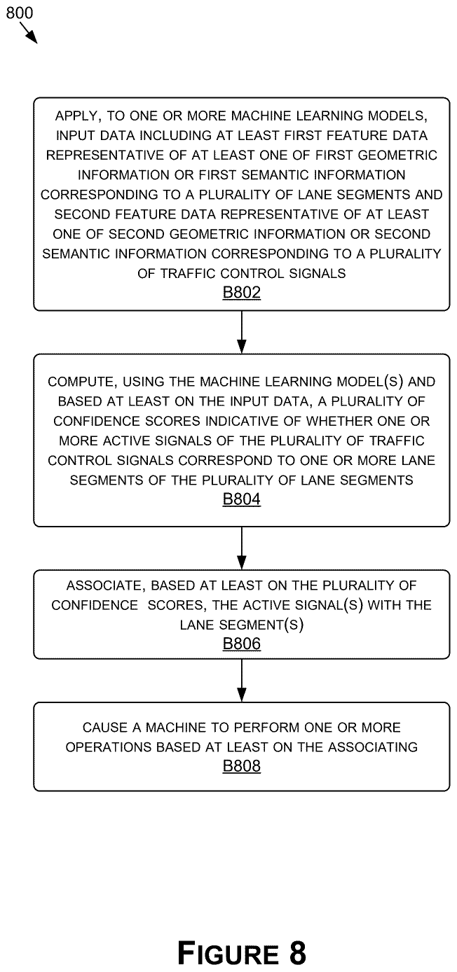

Now referring to FIGS. 8-10, each block of methods 800, 900, and 1000, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 800, 900, and 1000 are described, by way of example, with respect to FIG. 1. However, these methods may additionally or alternatively be executed by any one system, or any combination of systems, including, but not limited to, those described herein.

FIG. 8 is a flow diagram illustrating an example of a method 800 for associating active traffic control signals to lane segments, in accordance with some embodiments of the present disclosure. The method 800, at block B802, may include applying, to one or more machine learning models, input data including at least first feature data representative of at least one of first geometric information or first semantic information corresponding to a plurality of lane segments and second feature data representative of at least one of second geometric information or second semantic information corresponding to a plurality of traffic control signals. For instance, the lane feature(s) 116 and the traffic control device feature(s) 118 may be applied to the machine learning model(s) 108. The lane feature(s) 116 may, in some examples, include one or more feature vectors indicative of lane geometry and/or lane semantics (e.g., lane directions). The traffic control device feature(s) 118 may, in some instances, include one or more feature vectors indicative of geometry (e.g., shape, location, etc.) and/or semantics (e.g., intended road users, state, etc.) associated with traffic control devices (e.g., active traffic lights).

The method 800, at block B804, may include computing, using the machine learning model(s) and based at least on the input data, a plurality of confidence scores indicative of whether one or more active signals of the plurality of traffic control signals correspond to one or more lane segments of the plurality of lane segments. For instance, the machine learning model(s) 108 may compute the confidence score(s) 120 based at least on the lane feature(s) 116 and/or the traffic control device feature(s) 118.

The method 800, at block B806, may include associating, based at least on the plurality of confidence scores, the active signal(s) with the lane segment(s). For instance, the association component 110 may associate the active signal(s) with the lane segment(s) based at least on the confidence score(s) 120 computed by the machine learning model(s) 108. In some instances, the association component 110 may analyze the confidence score(s) 120 and/or other data (e.g., geometric or 3D proximity) to determine whether to associate a traffic control device with a lane. For instance, the association component 110 may determine the highest value confidence scores for every lane to traffic control device pair, and then select the highest scoring pairs as the valid pairs. In some instances, the association component 110 may determine whether the highest scoring pairs score higher than lower scoring pairs by more than a threshold before identifying a pair as a valid pair. For instance, if two potential pairs of light to lane associations seem possible based on having similar value confidence scores, the association component 110 may output an uncertainty regarding the pair, or refrain from outputting a valid pair at all.

The method 800, at block B808, may include causing a machine to perform one or more operations based at least on the associating. For instance, the drive stack component(s) 112 may cause the machine to perform the operation(s) based at least on the traffic control device to lane association(s) 122. In various examples, the operation(s) may include, but are not limited to, causing the machine to stop, causing the machine to change lanes, causing the machine to maintain its current trajectory, causing the machine to update a path, etc.

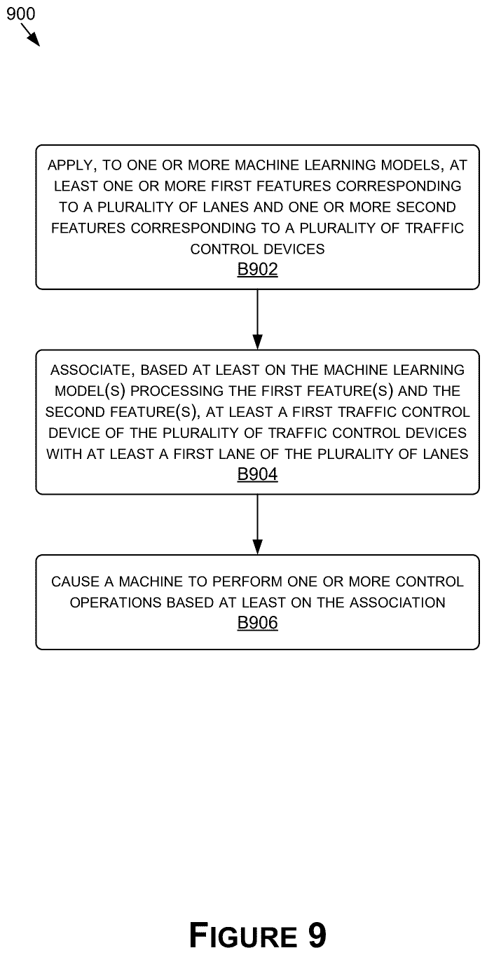

Referring now to FIG. 9, FIG. 9 is a flow diagram illustrating an example of a method 900 for associating traffic control devices to lanes, in accordance with some embodiments of the present disclosure. The method 900, at block B902, may include applying, to one or more machine learning models, at least one or more first features corresponding to a plurality of lanes and one or more second features corresponding to a plurality of traffic control devices. For instance, the lane feature(s) 116 and the traffic control device feature(s) 118 may be applied to the machine learning model(s) 108. The lane feature(s) 116 may, in some examples, include one or more feature vectors indicative of lane geometry and/or lane semantics (e.g., lane directions). The traffic control device feature(s) 118 may, in some instances, include one or more feature vectors indicative of geometry (e.g., shape, location, etc.) and/or semantics (e.g., intended road users, state, etc.) associated with traffic control devices (e.g., active traffic lights).

The method 900, at block B904, may include associating, based at least on the machine learning model(s) processing the first feature(s) and the second feature(s), at least a first traffic control device of the plurality of traffic control devices with at least a first lane of the plurality of lanes. For instance, the association component 110 may determine the traffic control device to lane association(s) 122, which may include associating the first traffic control device with the first lane segment, based at least on the confidence score(s) 120 computed by the machine learning model(s) 108. In some instances, the association component 110 may analyze the confidence score(s) 120 and/or other data (e.g., geometric or 3D proximity) to determine whether to associate a traffic control device with a lane. For instance, the association component 110 may determine the highest value confidence scores for every lane to traffic control device pair, and then select the highest scoring pairs as the valid pairs. In some instances, the association component 110 may determine whether the highest scoring pairs score higher than lower scoring pairs by more than a threshold before identifying a pair as a valid pair. For instance, if two potential pairs of light to lane associations seem possible based on having similar value confidence scores, the association component 110 may output an uncertainty regarding the pair, or refrain from outputting a valid pair at all.

The method 900, at block B906, may include causing a machine to perform one or more control operations based at least on the association. For instance, the drive stack component(s) 112 may cause the machine to perform the operation(s) based at least on the traffic control device to lane association(s) 122. In various examples, the operation(s) may include, but are not limited to, causing the machine to stop, causing the machine to change lanes, causing the machine to maintain its current trajectory, causing the machine to update a path, etc.

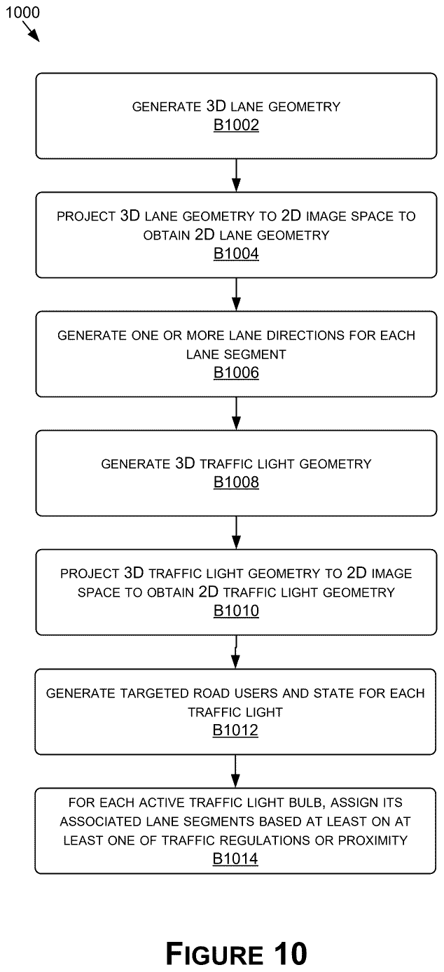

FIG. 10 is a flow diagram illustrating an example of a method 1000 for synthetically generating data for use to train a machine learning model to determine traffic control device to lane associations, in accordance with some embodiments of the present disclosure. The method 1000, at block B1002, may include generating 3D lane geometry. For instance, the dataset generator 616 may generate the 3D lane geometry. In some examples, the dataset generator 616 may generate the 3D lane geometry based at least on the rule data 618, which may represent traffic regulations. The traffic regulations may indicate valid lane width ranges. In some examples, a random number of lanes may be generated.

The method 1000, at block B1004, may include projecting the 3D lane geometry to 2D image space to obtain 2D lane geometry. For instance, the dataset generator 616 may project the 3D lane geometry to the 2D image space to obtain the 2D lane geometry. In some examples, the projection of the 3D lane geometry to 2D image space may be performed using camera intrinsic or extrinsic parameters. The method 1000, at block B1006, may include generating one or more lane directions for each lane segment. For instance, the dataset generator 616 may generate the lane directions for each of the lane segments. In some examples, the dataset generator 616 may generate the lane directions for each of the lane segments based on traffic regulations in the rule data 618 (e.g., in a right-hand driving, right turn lanes should be the rightmost lanes).

The method 1000, at block B1008, may include generating 3D traffic light geometry. For instance, the dataset generator 616 may generate the 3D traffic light geometry. In some examples, the dataset generator 616 may generate the 3D traffic light geometry based on the traffic regulations in the rule data 618 (e.g., where valid traffic light placement over lanes and traffic light sizes are specified) and give a random seed for the number of lights. The method 1000, at block B1010, may include projecting the 3D traffic light geometry to 2D image space to obtain 2D traffic light geometry. For instance, the dataset generator 616 may project the 3D traffic light geometry to the 2D image space to obtain the 2D traffic light geometry. In some examples, the projection of the 3D traffic light geometry to the 2D image space may be performed using the camera intrinsic and/or extrinsic parameters.

The method 1000, at block B1012, may include generating targeted road users and state for each traffic light. For instance, the dataset generator 616 may generate the targeted road users and the state for each of the traffic lights. In some examples,, the dataset generator 616 may generate the targeted road users and the state for each of the traffic lights based on the traffic regulations. In some instances, for a traffic light bulb with more than one arrow (e.g., arrow left and arrow straight), the state may be represented as multiple arrow states.

The method 1000, at block B1014, may include, for each active traffic light bulb, assigning its associated lane segments based at least on at least one of traffic regulations or proximity. For instance, the dataset generator 616 may assign each of the traffic light bulbs to their associated lane segments based at least on the traffic regulations or proximity of the traffic light bulbs to the lane segments. For example, the bulbs may be paired with lane segments based on a priority order that follows the traffic regulations. Such a priority order may include, but is not limited to (e.g., other combinations or orders are possible), (1) lights for road users other than vehicles do not associate with any lane segment; (2) lights not facing ego road (from orientation) or not at current intersection (from 3D geometry); (3) if U-turn arrow bulb is present, it controls the U-turn lanes only; (4) if left arrow bulb is present, it controls the left turn lanes; and if U-turn bulb is not present, it also controls the left U-turn lanes; (5) if right arrow bulb is present, it controls the right turn lanes; (6) if solid circle bulb is present, it controls the remaining lanes; (7) if straight arrow bulb is present, it controls the straight lanes. Additionally, or alternatively, for each active traffic light bulb, its associated lane segment(s) may be assigned based on proximity of the traffic light to its nearest lane segment in 3D.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, autonomous or semi-autonomous machine applications, deep learning, environment simulation, traffic control device to lane association, data center processing, conversational AI, light transport simulation (e.g., ray tracing, path tracing, etc.), collaborative content creation for 3D assets, cloud computing, generative AI, (large) language models, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for associating traffic control devices to lane segment directions, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, systems for performing generative AI operations, systems implementing—or for performing operations using—a large language model (LLM), and/or other types of systems.

### Example Autonomous Vehicle

FIG. 11A is an illustration of an example autonomous vehicle 1100, in accordance with some embodiments of the present disclosure. The autonomous vehicle 1100 (alternatively referred to herein as the “vehicle 1100”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1100 may be capable of functionality in accordance with one or more of Level 3-Level 5 of the autonomous driving levels. The vehicle 1100 may be capable of functionality in accordance with one or more of Level 1-Level 5 of the autonomous driving levels. For example, the vehicle 1100 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1100 or other machine, such as being fully autonomous, being highly autonomous, being conditionally autonomous, being partially autonomous, providing assistive autonomy, being semi-autonomous, being primarily autonomous, or other designation.

The vehicle 1100 may include components such as a chassis, a vehicle body, wheels (e.g., 2, 4, 6, 8, 18, etc.), tires, axles, and other components of a vehicle. The vehicle 1100 may include a propulsion system 1150, such as an internal combustion engine, hybrid electric power plant, an all-electric engine, and/or another propulsion system type. The propulsion system 1150 may be connected to a drive train of the vehicle 1100, which may include a transmission, to enable the propulsion of the vehicle 1100. The propulsion system 1150 may be controlled in response to receiving signals from the throttle/accelerator 1152.

A steering system 1154, which may include a steering wheel, may be used to steer the vehicle 1100 (e.g., along a desired path or route) when the propulsion system 1150 is operating (e.g., when the vehicle is in motion). The steering system 1154 may receive signals from a steering actuator 1156. The steering wheel may be optional for full automation (Level 5) functionality.

The brake sensor system 1146 may be used to operate the vehicle brakes in response to receiving signals from the brake actuators 1148 and/or brake sensors.

Controller(s) 1136, which may include one or more system on chips (SoCs) 1104 (FIG. 11C) and/or GPU(s), may provide signals (e.g., representative of commands) to one or more components and/or systems of the vehicle 1100. For example, the controller(s) may send signals to operate the vehicle brakes via one or more brake actuators 1148, to operate the steering system 1154 via one or more steering actuators 1156, to operate the propulsion system 1150 via one or more throttle/accelerators 1152. The controller(s) 1136 may include one or more onboard (e.g., integrated) computing devices (e.g., supercomputers) that process sensor signals, and output operation commands (e.g., signals representing commands) to enable autonomous driving and/or to assist a human driver in driving the vehicle 1100. The controller(s) 1136 may include a first controller 1136 for autonomous driving functions, a second controller 1136 for functional safety functions, a third controller 1136 for artificial intelligence functionality (e.g., computer vision), a fourth controller 1136 for infotainment functionality, a fifth controller 1136 for redundancy in emergency conditions, and/or other controllers. In some examples, a single controller 1136 may handle two or more of the above functionalities, two or more controllers 1136 may handle a single functionality, and/or any combination thereof.

The controller(s) 1136 may provide the signals for controlling one or more components and/or systems of the vehicle 1100 in response to sensor data received from one or more sensors (e.g., sensor inputs). The sensor data may be received from, for example and without limitation, global navigation satellite systems (“GNSS”) sensor(s) 1158 (e.g., Global Positioning System sensor(s)), RADAR sensor(s) 1160, ultrasonic sensor(s) 1162, LIDAR sensor(s) 1164, inertial measurement unit (IMU) sensor(s) 1166 (e.g., accelerometer(s), gyroscope(s), magnetic compass(es), magnetometer(s), etc.), microphone(s) 1196, stereo camera(s) 1168, wide-view camera(s) 1170 (e.g., fisheye cameras), infrared camera(s) 1172, surround camera(s) 1174 (e.g., 360 degree cameras), long-range and/or mid-range camera(s) 1198, speed sensor(s) 1144 (e.g., for measuring the speed of the vehicle 1100), vibration sensor(s) 1142, steering sensor(s) 1140, brake sensor(s) (e.g., as part of the brake sensor system 1146), and/or other sensor types.

One or more of the controller(s) 1136 may receive inputs (e.g., represented by input data) from an instrument cluster 1132 of the vehicle 1100 and provide outputs (e.g., represented by output data, display data, etc.) via a human-machine interface (HMI) display 1134, an audible annunciator, a loudspeaker, and/or via other components of the vehicle 1100. The outputs may include information such as vehicle velocity, speed, time, map data (e.g., the High Definition (“HD”) map 1122 of FIG. 11C), location data (e.g., the vehicle's 1100 location, such as on a map), direction, location of other vehicles (e.g., an occupancy grid), information about objects and status of objects as perceived by the controller(s) 1136, etc. For example, the HMI display 1134 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1100 further includes a network interface 1124 which may use one or more wireless antenna(s) 1126 and/or modem(s) to communicate over one or more networks. For example, the network interface 1124 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1126 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 11B is an example of camera locations and fields of view for the example autonomous vehicle 1100 of FIG. 11A, in accordance with some embodiments of the present disclosure. The cameras and respective fields of view are one example embodiment and are not intended to be limiting. For example, additional and/or alternative cameras may be included and/or the cameras may be located at different locations on the vehicle 1100.

The camera types for the cameras may include, but are not limited to, digital cameras that may be adapted for use with the components and/or systems of the vehicle 1100. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1100 (e.g., front-facing cameras) may be used for surround view, to help identify forward facing paths and obstacles, as well aid in, with the help of one or more controllers 1136 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1170 that may be used to perceive objects coming into view from the periphery (e.g., pedestrians, crossing traffic or bicycles). Although only one wide-view camera is illustrated in FIG. 11B, there may be any number (including zero) of wide-view cameras 1170 on the vehicle 1100. In addition, any number of long-range camera(s) 1198 (e.g., a long-view stereo camera pair) may be used for depth-based object detection, especially for objects for which a neural network has not yet been trained. The long-range camera(s) 1198 may also be used for object detection and classification, as well as basic object tracking.

Any number of stereo cameras 1168 may also be included in a front-facing configuration. In at least one embodiment, one or more of stereo camera(s) 1168 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1168 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1168 may be used in addition to, or alternatively from, those described herein.

Cameras with a field of view that include portions of the environment to the side of the vehicle 1100 (e.g., side-view cameras) may be used for surround view, providing information used to create and update the occupancy grid, as well as to generate side impact collision warnings. For example, surround camera(s) 1174 (e.g., four surround cameras 1174 as illustrated in FIG. 11B) may be positioned to on the vehicle 1100. The surround camera(s) 1174 may include wide-view camera(s) 1170, fisheye camera(s), 360 degree camera(s), and/or the like. Four example, four fisheye cameras may be positioned on the vehicle's front, rear, and sides. In an alternative arrangement, the vehicle may use three surround camera(s) 1174 (e.g., left, right, and rear), and may leverage one or more other camera(s) (e.g., a forward-facing camera) as a fourth surround view camera.

Cameras with a field of view that include portions of the environment to the rear of the vehicle 1100 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1198, stereo camera(s) 1168), infrared camera(s) 1172, etc.), as described herein.

FIG. 11C is a block diagram of an example system architecture for the example autonomous vehicle 1100 of FIG. 11A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1100 in FIG. 11C are illustrated as being connected via bus 1102. The bus 1102 may include a Controller Area Network (CAN) data interface (alternatively referred to herein as a “CAN bus”). A CAN may be a network inside the vehicle 1100 used to aid in control of various features and functionality of the vehicle 1100, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1102 is described herein as being a CAN bus, this is not intended to be limiting. For example, in addition to, or alternatively from, the CAN bus, FlexRay and/or Ethernet may be used. Additionally, although a single line is used to represent the bus 1102, this is not intended to be limiting. For example, there may be any number of busses 1102, which may include one or more CAN busses, one or more FlexRay busses, one or more Ethernet busses, and/or one or more other types of busses using a different protocol. In some examples, two or more busses 1102 may be used to perform different functions, and/or may be used for redundancy. For example, a first bus 1102 may be used for collision avoidance functionality and a second bus 1102 may be used for actuation control. In any example, each bus 1102 may communicate with any of the components of the vehicle 1100, and two or more busses 1102 may communicate with the same components. In some examples, each SoC 1104, each controller 1136, and/or each computer within the vehicle may have access to the same input data (e.g., inputs from sensors of the vehicle 1100), and may be connected to a common bus, such the CAN bus.

The vehicle 1100 may include one or more controller(s) 1136, such as those described herein with respect to FIG. 11A. The controller(s) 1136 may be used for a variety of functions. The controller(s) 1136 may be coupled to any of the various other components and systems of the vehicle 1100, and may be used for control of the vehicle 1100, artificial intelligence of the vehicle 1100, infotainment for the vehicle 1100, and/or the like.

The vehicle 1100 may include a system(s) on a chip (SoC) 1104. The SoC 1104 may include CPU(s) 1106, GPU(s) 1108, processor(s) 1110, cache(s) 1112, accelerator(s) 1114, data store(s) 1116, and/or other components and features not illustrated. The SoC(s) 1104 may be used to control the vehicle 1100 in a variety of platforms and systems. For example, the SoC(s) 1104 may be combined in a system (e.g., the system of the vehicle 1100) with an HD map 1122 which may obtain map refreshes and/or updates via a network interface 1124 from one or more servers (e.g., server(s) 1178 of FIG. 11D).

The CPU(s) 1106 may include a CPU cluster or CPU complex (alternatively referred to herein as a “CCPLEX”). The CPU(s) 1106 may include multiple cores and/or L2 caches. For example, in some embodiments, the CPU(s) 1106 may include eight cores in a coherent multi-processor configuration. In some embodiments, the CPU(s) 1106 may include four dual-core clusters where each cluster has a dedicated L2 cache (e.g., a 2 MB L2 cache). The CPU(s) 1106 (e.g., the CCPLEX) may be configured to support simultaneous cluster operation enabling any combination of the clusters of the CPU(s) 1106 to be active at any given time.

The CPU(s) 1106 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1106 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1108 may include an integrated GPU (alternatively referred to herein as an “iGPU”). The GPU(s) 1108 may be programmable and may be efficient for parallel workloads. The GPU(s) 1108, in some examples, may use an enhanced tensor instruction set. The GPU(s) 1108 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1108 may include at least eight streaming microprocessors. The GPU(s) 1108 may use compute application programming interface(s) (API(s)). In addition, the GPU(s) 1108 may use one or more parallel computing platforms and/or programming models (e.g., NVIDIA's CUDA).

The GPU(s) 1108 may be power-optimized for best performance in automotive and embedded use cases. For example, the GPU(s) 1108 may be fabricated on a Fin field-effect transistor (FinFET). However, this is not intended to be limiting and the GPU(s) 1108 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1108 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1108 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1108 to access the CPU(s) 1106 page tables directly. In such examples, when the GPU(s) 1108 memory management unit (MMU) experiences a miss, an address translation request may be transmitted to the CPU(s) 1106. In response, the CPU(s) 1106 may look in its page tables for the virtual-to-physical mapping for the address and transmits the translation back to the GPU(s) 1108. As such, unified memory technology may allow a single unified virtual address space for memory of both the CPU(s) 1106 and the GPU(s) 1108, thereby simplifying the GPU(s) 1108 programming and porting of applications to the GPU(s) 1108.

In addition, the GPU(s) 1108 may include an access counter that may keep track of the frequency of access of the GPU(s) 1108 to memory of other processors. The access counter may help ensure that memory pages are moved to the physical memory of the processor that is accessing the pages most frequently.

The SoC(s) 1104 may include any number of cache(s) 1112, including those described herein. For example, the cache(s) 1112 may include an L3 cache that is available to both the CPU(s) 1106 and the GPU(s) 1108 (e.g., that is connected both the CPU(s) 1106 and the GPU(s) 1108). The cache(s) 1112 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1104 may include an arithmetic logic unit(s) (ALU(s)) which may be leveraged in performing processing with respect to any of the variety of tasks or operations of the vehicle 1100—such as processing DNNs. In addition, the SoC(s) 1104 may include a floating point unit(s) (FPU(s))—or other math coprocessor or numeric coprocessor types—for performing mathematical operations within the system. For example, the SoC(s) 1104 may include one or more FPUs integrated as execution units within a CPU(s) 1106 and/or GPU(s) 1108.

The SoC(s) 1104 may include one or more accelerators 1114 (e.g., hardware accelerators, software accelerators, or a combination thereof). For example, the SoC(s) 1104 may include a hardware acceleration cluster that may include optimized hardware accelerators and/or large on-chip memory. The large on-chip memory (e.g., 4MB of SRAM), may enable the hardware acceleration cluster to accelerate neural networks and other calculations. The hardware acceleration cluster may be used to complement the GPU(s) 1108 and to off-load some of the tasks of the GPU(s) 1108 (e.g., to free up more cycles of the GPU(s) 1108 for performing other tasks). As an example, the accelerator(s) 1114 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1114 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1108, and by using an inference accelerator, for example, a designer may target either the DLA(s) or the GPU(s) 1108 for any function. For example, the designer may focus processing of CNNs and floating point operations on the DLA(s) and leave other functions to the GPU(s) 1108 and/or other accelerator(s) 1114.

The accelerator(s) 1114 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1106. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1114 (e.g., the hardware acceleration cluster) may include a computer vision network on-chip and SRAM, for providing a high-bandwidth, low latency SRAM for the accelerator(s) 1114. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1104 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1114 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1166 output that correlates with the vehicle 1100 orientation, distance, 3D location estimates of the object obtained from the neural network and/or other sensors (e.g., LIDAR sensor(s) 1164 or RADAR sensor(s) 1160), among others.

The SoC(s) 1104 may include data store(s) 1116 (e.g., memory). The data store(s) 1116 may be on-chip memory of the SoC(s) 1104, which may store neural networks to be executed on the GPU and/or the DLA. In some examples, the data store(s) 1116 may be large enough in capacity to store multiple instances of neural networks for redundancy and safety. The data store(s) 1112 may comprise L2 or L3 cache(s) 1112. Reference to the data store(s) 1116 may include reference to the memory associated with the PVA, DLA, and/or other accelerator(s) 1114, as described herein.

The SoC(s) 1104 may include one or more processor(s) 1110 (e.g., embedded processors). The processor(s) 1110 may include a boot and power management processor that may be a dedicated processor and subsystem to handle boot power and management functions and related security enforcement. The boot and power management processor may be a part of the SoC(s) 1104 boot sequence and may provide runtime power management services. The boot power and management processor may provide clock and voltage programming, assistance in system low power state transitions, management of SoC(s) 1104 thermals and temperature sensors, and/or management of the SoC(s) 1104 power states. Each temperature sensor may be implemented as a ring-oscillator whose output frequency is proportional to temperature, and the SoC(s) 1104 may use the ring-oscillators to detect temperatures of the CPU(s) 1106, GPU(s) 1108, and/or accelerator(s) 1114. If temperatures are determined to exceed a threshold, the boot and power management processor may enter a temperature fault routine and put the SoC(s) 1104 into a lower power state and/or put the vehicle 1100 into a chauffeur to safe stop mode (e.g., bring the vehicle 1100 to a safe stop).

The processor(s) 1110 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1110 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1110 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1110 may further include a real-time camera engine that may include a dedicated processor subsystem for handling real-time camera management.

The processor(s) 1110 may further include a high-dynamic range signal processor that may include an image signal processor that is a hardware engine that is part of the camera processing pipeline.

The processor(s) 1110 may include a video image compositor that may be a processing block (e.g., implemented on a microprocessor) that implements video post-processing functions needed by a video playback application to produce the final image for the player window. The video image compositor may perform lens distortion correction on wide-view camera(s) 1170, surround camera(s) 1174, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1108 is not required to continuously render new surfaces. Even when the GPU(s) 1108 is powered on and active doing 3D rendering, the video image compositor may be used to offload the GPU(s) 1108 to improve performance and responsiveness.

The SoC(s) 1104 may further include a mobile industry processor interface (MIPI) camera serial interface for receiving video and input from cameras, a high-speed interface, and/or a video input block that may be used for camera and related pixel input functions. The SoC(s) 1104 may further include an input/output controller(s) that may be controlled by software and may be used for receiving I/O signals that are uncommitted to a specific role.

The SoC(s) 1104 may further include a broad range of peripheral interfaces to enable communication with peripherals, audio codecs, power management, and/or other devices. The SoC(s) 1104 may be used to process data from cameras (e.g., connected over Gigabit Multimedia Serial Link and Ethernet), sensors (e.g., LIDAR sensor(s) 1164, RADAR sensor(s) 1160, etc. that may be connected over Ethernet), data from bus 1102 (e.g., speed of vehicle 1100, steering wheel position, etc.), data from GNSS sensor(s) 1158 (e.g., connected over Ethernet or CAN bus). The SoC(s) 1104 may further include dedicated high-performance mass storage controllers that may include their own DMA engines, and that may be used to free the CPU(s) 1106 from routine data management tasks.

The SoC(s) 1104 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1104 may be faster, more reliable, and even more energy-efficient and space-efficient than conventional systems. For example, the accelerator(s) 1114, when combined with the CPU(s) 1106, the GPU(s) 1108, and the data store(s) 1116, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1120) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1108.

In some examples, a CNN for facial recognition and vehicle owner identification may use data from camera sensors to identify the presence of an authorized driver and/or owner of the vehicle 1100. The always on sensor processing engine may be used to unlock the vehicle when the owner approaches the driver door and turn on the lights, and, in security mode, to disable the vehicle when the owner leaves the vehicle. In this way, the SoC(s) 1104 provide for security against theft and/or carjacking.

In another example, a CNN for emergency vehicle detection and identification may use data from microphones 1196 to detect and identify emergency vehicle sirens. In contrast to conventional systems, that use general classifiers to detect sirens and manually extract features, the SoC(s) 1104 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1158. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1162, until the emergency vehicle(s) passes.

The vehicle may include a CPU(s) 1118 (e.g., discrete CPU(s), or dCPU(s)), that may be coupled to the SoC(s) 1104 via a high-speed interconnect (e.g., PCIe). The CPU(s) 1118 may include an X86 processor, for example. The CPU(s) 1118 may be used to perform any of a variety of functions, including arbitrating potentially inconsistent results between ADAS sensors and the SoC(s) 1104, and/or monitoring the status and health of the controller(s) 1136 and/or infotainment SoC 1130, for example.

The vehicle 1100 may include a GPU(s) 1120 (e.g., discrete GPU(s), or dGPU(s)), that may be coupled to the SoC(s) 1104 via a high-speed interconnect (e.g., NVIDIA's NVLINK). The GPU(s) 1120 may provide additional artificial intelligence functionality, such as by executing redundant and/or different neural networks, and may be used to train and/or update neural networks based on input (e.g., sensor data) from sensors of the vehicle 1100.

The vehicle 1100 may further include the network interface 1124 which may include one or more wireless antennas 1126 (e.g., one or more wireless antennas for different communication protocols, such as a cellular antenna, a Bluetooth antenna, etc.). The network interface 1124 may be used to enable wireless connectivity over the Internet with the cloud (e.g., with the server(s) 1178 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1100 information about vehicles in proximity to the vehicle 1100 (e.g., vehicles in front of, on the side of, and/or behind the vehicle 1100). This functionality may be part of a cooperative adaptive cruise control functionality of the vehicle 1100.

The network interface 1124 may include a SoC that provides modulation and demodulation functionality and enables the controller(s) 1136 to communicate over wireless networks. The network interface 1124 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1100 may further include data store(s) 1128 which may include off-chip (e.g., off the SoC(s) 1104) storage. The data store(s) 1128 may include one or more storage elements including RAM, SRAM, DRAM, VRAM, Flash, hard disks, and/or other components and/or devices that may store at least one bit of data.

The vehicle 1100 may further include GNSS sensor(s) 1158. The GNSS sensor(s) 1158 (e.g., GPS, assisted GPS sensors, differential GPS (DGPS) sensors, etc.), to assist in mapping, perception, occupancy grid generation, and/or path planning functions. Any number of GNSS sensor(s) 1158 may be used, including, for example and without limitation, a GPS using a USB connector with an Ethernet to Serial (RS-232) bridge.

The vehicle 1100 may further include RADAR sensor(s) 1160. The RADAR sensor(s) 1160 may be used by the vehicle 1100 for long-range vehicle detection, even in darkness and/or severe weather conditions. RADAR functional safety levels may be ASIL B. The RADAR sensor(s) 1160 may use the CAN and/or the bus 1102 (e.g., to transmit data generated by the RADAR sensor(s) 1160) for control and to access object tracking data, with access to Ethernet to access raw data in some examples. A wide variety of RADAR sensor types may be used. For example, and without limitation, the RADAR sensor(s) 1160 may be suitable for front, rear, and side RADAR use. In some example, Pulse Doppler RADAR sensor(s) are used.

The RADAR sensor(s) 1160 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1160 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1100 surroundings at higher speeds with minimal interference from traffic in adjacent lanes. The other two antennae may expand the field of view, making it possible to quickly detect vehicles entering or leaving the vehicle's 1100 lane.

Mid-range RADAR systems may include, as an example, a range of up to 1160 m (front) or 80 m (rear), and a field of view of up to 42 degrees (front) or 1150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1100 may further include ultrasonic sensor(s) 1162. The ultrasonic sensor(s) 1162, which may be positioned at the front, back, and/or the sides of the vehicle 1100, may be used for park assist and/or to create and update an occupancy grid. A wide variety of ultrasonic sensor(s) 1162 may be used, and different ultrasonic sensor(s) 1162 may be used for different ranges of detection (e.g., 2.5 m, 4 m). The ultrasonic sensor(s) 1162 may operate at functional safety levels of ASIL B.

The vehicle 1100 may include LIDAR sensor(s) 1164. The LIDAR sensor(s) 1164 may be used for object and pedestrian detection, emergency braking, collision avoidance, and/or other functions. The LIDAR sensor(s) 1164 may be functional safety level ASIL B. In some examples, the vehicle 1100 may include multiple LIDAR sensors 1164 (e.g., two, four, six, etc.) that may use Ethernet (e.g., to provide data to a Gigabit Ethernet switch).

In some examples, the LIDAR sensor(s) 1164 may be capable of providing a list of objects and their distances for a 360-degree field of view. Commercially available LIDAR sensor(s) 1164 may have an advertised range of approximately 1100 m, with an accuracy of 2 cm-3 cm, and with support for a 1100 Mbps Ethernet connection, for example. In some examples, one or more non-protruding LIDAR sensors 1164 may be used. In such examples, the LIDAR sensor(s) 1164 may be implemented as a small device that may be embedded into the front, rear, sides, and/or corners of the vehicle 1100. The LIDAR sensor(s) 1164, in such examples, may provide up to a 120-degree horizontal and 35-degree vertical field-of-view, with a 200 m range even for low-reflectivity objects. Front-mounted LIDAR sensor(s) 1164 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1100. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1164 may be less susceptible to motion blur, vibration, and/or shock.

The vehicle may further include IMU sensor(s) 1166. The IMU sensor(s) 1166 may be located at a center of the rear axle of the vehicle 1100, in some examples. The IMU sensor(s) 1166 may include, for example and without limitation, an accelerometer(s), a magnetometer(s), a gyroscope(s), a magnetic compass(es), and/or other sensor types. In some examples, such as in six-axis applications, the IMU sensor(s) 1166 may include accelerometers and gyroscopes, while in nine-axis applications, the IMU sensor(s) 1166 may include accelerometers, gyroscopes, and magnetometers.

In some embodiments, the IMU sensor(s) 1166 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1166 may enable the vehicle 1100 to estimate heading without requiring input from a magnetic sensor by directly observing and correlating the changes in velocity from GPS to the IMU sensor(s) 1166. In some examples, the IMU sensor(s) 1166 and the GNSS sensor(s) 1158 may be combined in a single integrated unit.

The vehicle may include microphone(s) 1196 placed in and/or around the vehicle 1100. The microphone(s) 1196 may be used for emergency vehicle detection and identification, among other things.

The vehicle may further include any number of camera types, including stereo camera(s) 1168, wide-view camera(s) 1170, infrared camera(s) 1172, surround camera(s) 1174, long-range and/or mid-range camera(s) 1198, and/or other camera types. The cameras may be used to capture image data around an entire periphery of the vehicle 1100. The types of cameras used depends on the embodiments and requirements for the vehicle 1100, and any combination of camera types may be used to provide the necessary coverage around the vehicle 1100. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 11A and FIG. 11B.

The vehicle 1100 may further include vibration sensor(s) 1142. The vibration sensor(s) 1142 may measure vibrations of components of the vehicle, such as the axle(s). For example, changes in vibrations may indicate a change in road surfaces. In another example, when two or more vibration sensors 1142 are used, the differences between the vibrations may be used to determine friction or slippage of the road surface (e.g., when the difference in vibration is between a power-driven axle and a freely rotating axle).

The vehicle 1100 may include an ADAS system 1138. The ADAS system 1138 may include a SoC, in some examples. The ADAS system 1138 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1160, LIDAR sensor(s) 1164, and/or a camera(s). The ACC systems may include longitudinal ACC and/or lateral ACC. Longitudinal ACC monitors and controls the distance to the vehicle immediately ahead of the vehicle 1100 and automatically adjust the vehicle speed to maintain a safe distance from vehicles ahead. Lateral ACC performs distance keeping, and advises the vehicle 1100 to change lanes when necessary. Lateral ACC is related to other ADAS applications such as LCA and CWS.

CACC uses information from other vehicles that may be received via the network interface 1124 and/or the wireless antenna(s) 1126 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1100), while the I2V communication concept provides information about traffic further ahead. CACC systems may include either or both I2V and V2V information sources. Given the information of the vehicles ahead of the vehicle 1100, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1160, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1160, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1100 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1100 if the vehicle 1100 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1160, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1100 is backing up. Some RCTW systems include AEB to ensure that the vehicle brakes are applied to avoid a crash. RCTW systems may use one or more rear-facing RADAR sensor(s) 1160, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1100, the vehicle 1100 itself must, in the case of conflicting results, decide whether to heed the result from a primary computer or a secondary computer (e.g., a first controller 1136 or a second controller 1136). For example, in some embodiments, the ADAS system 1138 may be a backup and/or secondary computer for providing perception information to a backup computer rationality module. The backup computer rationality monitor may run a redundant diverse software on hardware components to detect faults in perception and dynamic driving tasks. Outputs from the ADAS system 1138 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1104.

In other examples, ADAS system 1138 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1138 may be fed into the primary computer's perception block and/or the primary computer's dynamic driving task block. For example, if the ADAS system 1138 indicates a forward crash warning due to an object immediately ahead, the perception block may use this information when identifying objects. In other examples, the secondary computer may have its own neural network which is trained and thus reduces the risk of false positives, as described herein.

The vehicle 1100 may further include the infotainment SoC 1130 (e.g., an in-vehicle infotainment system (IVI)). Although illustrated and described as a SoC, the infotainment system may not be a SoC, and may include two or more discrete components. The infotainment SoC 1130 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1100. For example, the infotainment SoC 1130 may radios, disk players, navigation systems, video players, USB and Bluetooth connectivity, carputers, in-car entertainment, Wi-Fi, steering wheel audio controls, hands free voice control, a heads-up display (HUD), an HMI display 1134, a telematics device, a control panel (e.g., for controlling and/or interacting with various components, features, and/or systems), and/or other components. The infotainment SoC 1130 may further be used to provide information (e.g., visual and/or audible) to a user(s) of the vehicle, such as information from the ADAS system 1138, autonomous driving information such as planned vehicle maneuvers, trajectories, surrounding environment information (e.g., intersection information, vehicle information, road information, etc.), and/or other information.

The infotainment SoC 1130 may include GPU functionality. The infotainment SoC 1130 may communicate over the bus 1102 (e.g., CAN bus, Ethernet, etc.) with other devices, systems, and/or components of the vehicle 1100. In some examples, the infotainment SoC 1130 may be coupled to a supervisory MCU such that the GPU of the infotainment system may perform some self-driving functions in the event that the primary controller(s) 1136 (e.g., the primary and/or backup computers of the vehicle 1100) fail. In such an example, the infotainment SoC 1130 may put the vehicle 1100 into a chauffeur to safe stop mode, as described herein.

The vehicle 1100 may further include an instrument cluster 1132 (e.g., a digital dash, an electronic instrument cluster, a digital instrument panel, etc.). The instrument cluster 1132 may include a controller and/or supercomputer (e.g., a discrete controller or supercomputer). The instrument cluster 1132 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1130 and the instrument cluster 1132. In other words, the instrument cluster 1132 may be included as part of the infotainment SoC 1130, or vice versa.

FIG. 11D is a system diagram for communication between cloud-based server(s) and the example autonomous vehicle 1100 of FIG. 11A, in accordance with some embodiments of the present disclosure. The system 1176 may include server(s) 1178, network(s) 1190, and vehicles, including the vehicle 1100. The server(s) 1178 may include a plurality of GPUs 1184(A)-1184(H) (collectively referred to herein as GPUs 1184), PCIe switches 1182(A)-1182(H) (collectively referred to herein as PCIe switches 1182), and/or CPUs 1180(A)-1180(B) (collectively referred to herein as CPUs 1180). The GPUs 1184, the CPUs 1180, and the PCIe switches may be interconnected with high-speed interconnects such as, for example and without limitation, NVLink interfaces 1188 developed by NVIDIA and/or PCIe connections 1186. In some examples, the GPUs 1184 are connected via NVLink and/or NVSwitch SoC and the GPUs 1184 and the PCIe switches 1182 are connected via PCIe interconnects. Although eight GPUs 1184, two CPUs 1180, and two PCIe switches are illustrated, this is not intended to be limiting. Depending on the embodiment, each of the server(s) 1178 may include any number of GPUs 1184, CPUs 1180, and/or PCIe switches. For example, the server(s) 1178 may each include eight, sixteen, thirty-two, and/or more GPUs 1184.

The server(s) 1178 may receive, over the network(s) 1190 and from the vehicles, image data representative of images showing unexpected or changed road conditions, such as recently commenced road-work. The server(s) 1178 may transmit, over the network(s) 1190 and to the vehicles, neural networks 1192, updated neural networks 1192, and/or map information 1194, including information regarding traffic and road conditions. The updates to the map information 1194 may include updates for the HD map 1122, such as information regarding construction sites, potholes, detours, flooding, and/or other obstructions. In some examples, the neural networks 1192, the updated neural networks 1192, and/or the map information 1194 may have resulted from new training and/or experiences represented in data received from any number of vehicles in the environment, and/or based on training performed at a datacenter (e.g., using the server(s) 1178 and/or other servers).

The server(s) 1178 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1190, and/or the machine learning models may be used by the server(s) 1178 to remotely monitor the vehicles.

In some examples, the server(s) 1178 may receive data from the vehicles and apply the data to up-to-date real-time neural networks for real-time intelligent inferencing. The server(s) 1178 may include deep-learning supercomputers and/or dedicated AI computers powered by GPU(s) 1184, such as a DGX and DGX Station machines developed by NVIDIA. However, in some examples, the server(s) 1178 may include deep learning infrastructure that use only CPU-powered datacenters.

The deep-learning infrastructure of the server(s) 1178 may be capable of fast, real-time inferencing, and may use that capability to evaluate and verify the health of the processors, software, and/or associated hardware in the vehicle 1100. For example, the deep-learning infrastructure may receive periodic updates from the vehicle 1100, such as a sequence of images and/or objects that the vehicle 1100 has located in that sequence of images (e.g., via computer vision and/or other machine learning object classification techniques). The deep-learning infrastructure may run its own neural network to identify the objects and compare them with the objects identified by the vehicle 1100 and, if the results do not match and the infrastructure concludes that the AI in the vehicle 1100 is malfunctioning, the server(s) 1178 may transmit a signal to the vehicle 1100 instructing a fail-safe computer of the vehicle 1100 to assume control, notify the passengers, and complete a safe parking maneuver.

For inferencing, the server(s) 1178 may include the GPU(s) 1184 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). In other words, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that enable the computing device 1200 to communicate with other computing devices via an electronic communication network, included wired and/or wireless communications. The communication interface 1210 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may enable the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that enable detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to enable the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1333, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may utilize distributed file system 1338 for large-scale data processing (e.g., “big data”). In at least one embodiment, job scheduler 1333 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1333. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: applying, to one or more machine learning models, input data including at least: first feature data representative of at least one of first geometric information or first semantic information corresponding to a plurality of lane segments; and second feature data representative of at least one of second geometric information or second semantic information corresponding to a plurality of traffic control signals; computing, using the one or more machine learning models and based at least on the input data, a plurality of confidence scores indicative of whether one or more active signals of the plurality of traffic control signals correspond to one or more lane segments of the plurality of lane segments; associating, based at least on the plurality of confidence scores, the one or more active signals with the one or more lane segments; and causing a machine to perform one or more operations based at least on the association.
B. The method of claim 1, wherein the first semantic information corresponding to the plurality of lane segments includes at least one or more directions associated with the plurality of lane segments.
C. The method of claim 1, wherein the one or more machine learning models include one or more deep neural networks.
D. The method of claim 3, further comprising: synthetically generating one or more training datasets from non-visual data using one or more rules associated with traffic control signal device positioning relative to one or more corresponding lane segments; and training the one or more deep neural networks, at least in part, using the one or more training datasets.
E. The method of claim 1, wherein the associating of the one or more active signals with the one or more lane segments comprises, at least: associating one or more first active signals with one or more first lane segments having one or more first directions; and associating one or more second active signals with one or more second lane segments having one or more second directions.
F. The method of claim 1, wherein the first feature data and the second feature data include non-image features.
G. The method of claim 1, further comprising: comparing a first confidence score associated with a first pairing between a first active signal and a first lane segment with one or more second confidence scores associated with one or more second pairings between one or more second active signals and one or more second lane segments; determining, based at least on the comparing, that the first confidence score is greater than the one or more second confidence scores by more than a threshold; and associating, as a valid pair, the first active signal and the first lane segment based at least on the first confidence score being greater than the one or more second confidence scores by more than the threshold.
H. A system comprising: one or more processors to: apply, to one or more machine learning models, at least: one or more first features corresponding to a plurality of lanes; and one or more second features corresponding to a plurality of traffic control devices; associate, based at least on the one or more machine learning models processing the one or more first features and the one or more second features, at least a traffic control device of the plurality of traffic control devices with at least a lane of the plurality of lanes; and cause a machine to perform one or more control operations based at least on the association.
I. The system of claim 8, the one or more processors further to: synthetically generate at least one of training data or ground truth data from non visual data using one or more rules associated with positioning one or more traffic control devices relative to one or more corresponding lane segments.
J. The system of claim 8, wherein the one or more machine learning models include one or more deep neural networks (DNNs).
K. The system of claim 8, wherein the one or more first features and the one or more second features are non-image features.
L. The system of claim 8, wherein the one or more first features are indicative of at least one of: one or more geometries associated with the plurality of lanes; or one or more directions associated with the plurality of lanes.
M. The system of claim 8, wherein the one or more second features are indicative of at least one of: one or more geometries associated with the plurality of traffic control devices; one or more road user classifications associated with the plurality of traffic control devices; or one or more states associated with the plurality of traffic control devices.
N. The system of claim 8, the one or more processors further to: compute, using the one or more machine learning models and based at least on the one or more first features and the one or more second features, a plurality of scores indicative of whether the traffic control device corresponds to the lane or one or more second lanes of the plurality of lanes; and determine, based at least on a first score of the plurality of scores being greater than one or more second scores of the plurality of scores, that the traffic control device corresponds to the lane, wherein the association of the traffic control device with the lane is based at least on the first score being greater than the one or more second scores.
O. The system of claim 8, wherein the association of the traffic control device with the lane comprises associating, based at least on the one or more machine learning models processing the one or more first features and the one or more second features, one or more illuminated signals of the traffic control device with one or more directions associated with the lane.
P. The system of claim 8, the one or more processors further to: generate, using the one or more machine learning models, a binary matrix including a plurality of entries indicative of one or more valid pairings between respective traffic control devices of the plurality of traffic control devices and respective lanes of the plurality of lanes; and wherein the association of at least the traffic control device with the lane is based at least on the binary matrix.
Q. The system of claim 8, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using one or more vision language models (VLMs); a system for performing operations using one or more multi-modal language models; a system for using or deploying one or more inference microservices; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.
R. One or more processing units comprising: processing circuitry to update one or more parameters of one or more deep neural networks (DNNs) to train the one or more DNNs to associate one or more active traffic control signals with one or more directions of one or more lanes of a driving surface using a training dataset that is synthetically generated from non-visual data based at least on one or more rules associated with positioning one or more traffic control devices relative to one or more corresponding lane segments.
S. The one or more processing units of claim 18, wherein the training dataset is synthetically generated, at least, by: projecting three-dimensional (3D) geometry for a plurality of lanes to two dimensional (2D) image space based at least on one or more intrinsic or extrinsic camera parameters; projecting 3D geometry for a plurality of traffic control devices to 2D image space based at least on the one or more intrinsic or extrinsic camera parameters; and generating a plurality of traffic control device to lane pairs between the plurality of lanes and the plurality of traffic control devices based at least on one or more traffic regulations.
T. The one or more processing units of claim 18, wherein the one or more processing units are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using one or more vision language models (VLMs); a system for performing operations using one or more multi-modal language models; a system for using or deploying one or more inference microservices; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
applying, to one or more machine learning models, input data including at least:
first feature data representative of at least one of first geometric information or first semantic information corresponding to a plurality of lane segments; and
second feature data representative of at least one of second geometric information or second semantic information corresponding to a plurality of traffic control signals;
computing, using the one or more machine learning models and based at least on the input data, a plurality of confidence scores indicative of whether one or more active signals of the plurality of traffic control signals correspond to one or more lane segments of the plurality of lane segments;
associating, based at least on the plurality of confidence scores, the one or more active signals with the one or more lane segments; and
causing a machine to perform one or more operations based at least on the association.

2. The method of claim 1, wherein the first semantic information corresponding to the plurality of lane segments includes at least one or more directions associated with the plurality of lane segments.

3. The method of claim 1, wherein the one or more machine learning models include one or more deep neural networks.

4. The method of claim 3, further comprising:
synthetically generating one or more training datasets from non-visual data using one or more rules associated with traffic control signal device positioning relative to one or more corresponding lane segments; and
training the one or more deep neural networks, at least in part, using the one or more training datasets.

5. The method of claim 1, wherein the associating of the one or more active signals with the one or more lane segments comprises, at least:
associating one or more first active signals with one or more first lane segments having one or more first directions; and
associating one or more second active signals with one or more second lane segments having one or more second directions.

6. The method of claim 1, wherein the first feature data and the second feature data include non-image features.

7. The method of claim 1, further comprising:
comparing a first confidence score associated with a first pairing between a first active signal and a first lane segment with one or more second confidence scores associated with one or more second pairings between one or more second active signals and one or more second lane segments;
determining, based at least on the comparing, that the first confidence score is greater than the one or more second confidence scores by more than a threshold; and
associating, as a valid pair, the first active signal and the first lane segment based at least on the first confidence score being greater than the one or more second confidence scores by more than the threshold.

8. A system comprising:
one or more processors to:
apply, to one or more machine learning models, at least:
one or more first features corresponding to a plurality of lanes; and
one or more second features corresponding to a plurality of traffic control devices;
associate, based at least on the one or more machine learning models processing the one or more first features and the one or more second features, at least a traffic control device of the plurality of traffic control devices with at least a lane of the plurality of lanes; and
cause a machine to perform one or more control operations based at least on the association.

9. The system of claim 8, the one or more processors further to:
synthetically generate at least one of training data or ground truth data from non-visual data using one or more rules associated with positioning one or more traffic control devices relative to one or more corresponding lane segments.

10. The system of claim 8, wherein the one or more machine learning models include one or more deep neural networks (DNNs).

11. The system of claim 8, wherein the one or more first features and the one or more second features are non-image features.

12. The system of claim 8, wherein the one or more first features are indicative of at least one of:
one or more geometries associated with the plurality of lanes; or
one or more directions associated with the plurality of lanes.

13. The system of claim 8, wherein the one or more second features are indicative of at least one of:
one or more geometries associated with the plurality of traffic control devices;
one or more road user classifications associated with the plurality of traffic control devices; or
one or more states associated with the plurality of traffic control devices.

14. The system of claim 8, the one or more processors further to:
compute, using the one or more machine learning models and based at least on the one or more first features and the one or more second features, a plurality of scores indicative of whether the traffic control device corresponds to the lane or one or more second lanes of the plurality of lanes; and
determine, based at least on a first score of the plurality of scores being greater than one or more second scores of the plurality of scores, that the traffic control device corresponds to the lane,
wherein the association of the traffic control device with the lane is based at least on the first score being greater than the one or more second scores.

15. The system of claim 8, wherein the association of the traffic control device with the lane comprises associating, based at least on the one or more machine learning models processing the one or more first features and the one or more second features, one or more illuminated signals of the traffic control device with one or more directions associated with the lane.

16. The system of claim 8, the one or more processors further to:
generate, using the one or more machine learning models, a binary matrix including a plurality of entries indicative of one or more valid pairings between respective traffic control devices of the plurality of traffic control devices and respective lanes of the plurality of lanes; and
wherein the association of at least the traffic control device with the lane is based at least on the binary matrix.

17. The system of claim 8, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing operations using one or more multi-modal language models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

18. One or more processing units comprising:
processing circuitry to update one or more parameters of one or more deep neural networks (DNNs) to train the one or more DNNs to associate one or more active traffic control signals with one or more directions of one or more lanes of a driving surface using a training dataset that is synthetically generated from non-visual data based at least on one or more rules associated with positioning one or more traffic control devices relative to one or more corresponding lane segments.

19. The one or more processing units of claim 18, wherein the training dataset is synthetically generated, at least, by:
projecting three-dimensional (3D) geometry for a plurality of lanes to two-dimensional (2D) image space based at least on one or more intrinsic or extrinsic camera parameters;
projecting 3D geometry for a plurality of traffic control devices to 2D image space based at least on the one or more intrinsic or extrinsic camera parameters; and
generating a plurality of traffic control device to lane pairs between the plurality of lanes and the plurality of traffic control devices based at least on one or more traffic regulations.

20. The one or more processing units of claim 18, wherein the one or more processing units are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing operations using one or more multi-modal language models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
